(19) United States
(12) Patent Application Publication
(10) Pub. No.: US 2025/0251674 A1
(43) Pub. Date: Aug. 7, 2025

(54) ELECTROSTATIC CHARGE IMAGE DEVELOPING CARRIER, ELECTROSTATIC CHARGE IMAGE DEVELOPER, PROCESS CARTRIDGE, IMAGE FORMING METHOD, AND IMAGE FORMING APPARATUS

(71) Applicant: FUJIFILM Business Innovation Corp., Tokyo (JP)

(72) Inventors: Yosuke TSURUMI, Kanagawa (JP); Yasuo KADOKURA, Kanagawa (JP); Moegi IGUCHI, Kanagawa (JP); Ryo NAGAI, Kanagawa (JP)

(73) Assignee: FUJIFILM Business Innovation Corp., Tokyo (JP)

(21) Appl. No.: 18/929,522

(22) Filed: Oct. 28, 2024

(30) Foreign Application Priority Data
Feb. 1, 2024 (JP) 2024-014370

(51) Int. Cl. G03G 9/107; G03G 9/08; G03G 9/113

(52) U.S. Cl. CPC G03G 9/107; G03G 9/0819; G03G 9/0827; G03G 9/1136; G03G 2215/0607; G03G 2221/183

(57) ABSTRACT

An electrostatic charge image developing carrier contains magnetic particles and a resin coating layer on a surface of the magnetic particles, in which inorganic particles are provided on a surface of the electrostatic charge image developing carrier or contained in the resin coating layer, the inorganic particles contains Ti and any of Ca, Sr, or Ba, an average circularity of primary particles of the inorganic particles is 0.82 or more and 0.94 or less, and a BET specific surface area of the magnetic particles is 0.12 m²/g or more and 0.24 m²/g or less.

### CROSS-REFERENCE TO RELATED APPLICATIONS

This application is based on and claims priority under 35 USC 119 from Japanese Patent Application No. 2024-014370 filed Feb. 1, 2024.

### BACKGROUND

### (i) Technical Field

The present invention relates to an electrostatic charge image developing carrier, an electrostatic charge image developer, a process cartridge, an image forming method, and an image forming apparatus.

### (ii) Related Art

As an electrostatic charge image developing carrier, a resin-coated carrier having a resin coating layer on a surface of magnetic particles has been known. As the resin-coated carrier or a developer containing the resin-coated carrier, for example, the following are disclosed.

JP2021-71669A discloses a developer containing a toner and a carrier, in which the toner contains inorganic particles having a surface of particles containing Si, the particles containing Si have a number-average equivalent circle diameter of 5 nm to 15 nm, and the carrier has a surface of a core material particle coated with a coating layer containing a resin, and has a volume-average particle size of 45 μm to 70 μm and a bulk density of 2.10 g/cm³ to 2.50 g/cm³.

JP2020-91471A discloses a magnetic carrier containing magnetic carrier particles having magnetic carrier core particles and a resin coating layer formed on a surface of the magnetic carrier core particles, and inorganic fine particles A present on the surface of the magnetic carrier particles, in which the inorganic fine particles A have a rectangular particle shape, the inorganic fine particles A have a number-average particle size (D1) of 10 nm to 60 nm, the inorganic fine particles A are surface-treated with a surface treatment agent, a solubility parameter (SP1) (J/mol)^{1/2} of the resin coating layer and a solubility parameter (SP2) (J/mol)^{1/2} of the surface treatment agent satisfy the expression (1), and a coverage by the inorganic fine particles A, measured by X-ray photoelectron spectroscopy (ESCA) on the surface of the magnetic carrier, is 5.0 atom % to 20.0 atom %.

$$SP 1 - SP 2 \leq 14.00 \qquad ( 1 )$$

### SUMMARY

Aspects of non-limiting embodiments of the present disclosure relate to an electrostatic charge image developing carrier that is excellent in line density and white spot suppression property in an image to be obtained, compared to a case where inorganic particles are titania, an average circularity of primary particles of the inorganic particles is less than 0.82 or more than 0.94, or a BET specific surface area of the magnetic particles is less than 0.12 m²/g or more than 0.24 m²/g.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an electrostatic charge image developing carrier containing magnetic particles and a resin coating layer on a surface of the magnetic particles, in which inorganic particles are provided on a surface of the electrostatic charge image developing carrier or contained in the resin coating layer, the inorganic particles contains Ti and any of Ca, Sr, or Ba, an average circularity of primary particles of the inorganic particles is 0.82 or more and 0.94 or less, and a BET specific surface area of the magnetic particles is 0.12 m²/g or more and 0.24 m²/g or less.

### BRIEF DESCRIPTION OF THE DRAWINGS

Exemplary embodiment(s) of the present invention will be described in detail based on the following figures, wherein:

FIG. 1 is a view schematically showing an image used for evaluation of line density and white spot suppression property;

FIG. 2 is a view schematically showing an evaluation portion for a white spot suppression property evaluation in the image shown in FIG. 1;

FIG. 3 is a view schematically showing the configuration of an example of an image forming apparatus according to the present exemplary embodiment; and

FIG. 4 is a view schematically showing the configuration of an example of a process cartridge detachable from the image forming apparatus according to the present exemplary embodiment.

### DETAILED DESCRIPTION

Hereinafter, exemplary embodiments of the present invention will be described in detail with reference to the accompanying drawings.

In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, a numerical range described using “to” represents a range including numerical values listed before and after “to” as the minimum value and the maximum value respectively.

In the present specification, the term “step” includes not only an independent step but a step that is not clearly distinguished from other steps as long as the intended purpose of the step is achieved.

In the present specification, an “electrostatic charge image developing carrier” is also referred to as “carrier”, an “electrostatic charge image developing toner” is also referred to as “toner”, and an “electrostatic charge image developer” is also referred to as a “developer”.

### Electrostatic Charge Image Developing Carrier

An electrostatic charge image developing carrier according to the present exemplary embodiment contains magnetic particles and a resin coating layer on a surface of the magnetic particles, in which inorganic particles are provided on a surface of the electrostatic charge image developing carrier or contained in the resin coating layer, the inorganic particles contains Ti and any of Ca, Sr, or Ba, an average circularity of primary particles of the inorganic particles is 0.82 or more and 0.94 or less, and a BET specific surface area of the magnetic particles is 0.12 m²/g or more and 0.24 m²/g or less.

In the carrier of the related art, in a case where a thin line image is continuously printed under a low temperature and low humidity, line density may be low. In addition, in a combination image with different densities, such as a halftone image, inside a solid image after continuously printing the thin line image, the image of the boundary portion may not be printed and may be white. This is because the toner charging is increased and the density is difficult to obtain due to the continuous printing of the thin line image.

The electrostatic charge image developing carrier according to the present exemplary embodiment contains at least inorganic particles as an external additive or in the resin coating layer, in which the inorganic particles contain Ti and any one of Ca, Sr, or Ba, the average circularity of primary particles of the inorganic particles is 0.82 or more and 0.94 or less, and the BET specific surface area of the magnetic particles is 0.12 m²/g or more and 0.24 m²/g or less. In a case where the inorganic particles containing Ti and any one of Ca, Sr, or Ba are present, the inorganic particles have high dielectric properties and a moderate resistance, and thus it is possible to suppress a change in charging. In addition, due to the dielectric properties, it is possible to maintain charging, and due to the resistance, it is possible to suppress excessive charging.

In a case where the BET specific surface area of the magnetic particles is within the above-described range, an appropriate contact point between a core and the inorganic particles is formed, and an appropriate charge leak from the inorganic particles to the core occurs, so that electrostatic attraction and repulsion are suppressed, and an abundant amount of the carrier surface is stabilized.

In addition, in a case where the average circularity of the primary particles of the inorganic particles is within the above-described range, accumulation of the inorganic particles on the carrier surface is suppressed, and mobility of the inorganic particles on the carrier surface is also appropriate.

Therefore, in a case where the BET specific surface area and the circularity are within the above-described ranges, the effects are synergistically exhibited, the amount of the inorganic particles on the carrier is constant and the variation thereof is suppressed regardless of the external conditions, and the peeling of the inorganic particles from the carrier, that is likely to occur in low image density continuous printing under low temperature and low humidity, can be suppressed. Particularly, in printing with different image densities, the effects are obtained on the line density and the image white spots.

Hereinafter, the configuration of the electrostatic charge image developing carrier according to the present exemplary embodiment will be described in detail.

### Average Circularity of Primary Particles of Inorganic Particles

In the electrostatic charge image developing carrier according to the present exemplary embodiment, the average circularity of the primary particles of the inorganic particles is 0.82 to 0.94, and from the viewpoint of line density and white spot suppression property of an image to be obtained, the average circularity is, for example, preferably 0.85 or more and 0.94 or less, more preferably 0.88 or more and 0.93 or less, and particularly preferably 0.91 or more and 0.93 or less.

In the present exemplary embodiment, the average circularity of the inorganic particles is obtained by performing image analysis on at least 300 inorganic particles to obtain a circularity, creating a circularity distribution, and calculating the average circularity. In addition, from the created circularity distribution, a circularity of the inorganic particles at which a cumulative percentage reaches 84%, that will be described later, is obtained. The above-described inorganic particles refer to particles present on the surface of the carrier from which a toner is removed by air blowing using any mesh from an electrostatic charge image developer. In addition, in above-described the inorganic particles, each element on the carrier is mapped by energy dispersive X-ray analysis (SEM-EDX), and a titanate compound and the like are identified from the elements of each particle on the carrier.

### BET Specific Surface Area of Magnetic Particles

In the electrostatic charge image developing carrier according to the present exemplary embodiment, the BET specific surface area of the magnetic particles is 0.12 m²/g or more and 0.24 m²/g or less, and from the viewpoint of line density and white spot suppression property of an image to be obtained, the BET specific surface area is, for example, preferably 0.13 m²/g or more and 0.23 m²/g or less, more preferably 0.15 m²/g or more and 0.23 m²/g or less, and particularly preferably 0.16 m²/g or more and 0.22 m²/g or less.

A method for measuring the BET specific surface area of the magnetic particles in the present exemplary embodiment is as follows.

The toner is removed from the electrostatic charge image developer by air blowing using any mesh. Thereafter, the coating film is removed with a solvent to obtain magnetic particles.

The obtained magnetic particles are placed in a cell of SA3100 specific surface area measuring device (manufactured by Beckman Coulter, Inc.), subjected to a deaeration treatment at 60° C. for 120 minutes, purged with a mixed gas of nitrogen and helium (volume ratio: 30:70), and measured by a continuous one-point method.

### Inorganic Particles

The electrostatic charge image developing carrier according to the present exemplary embodiment contains the magnetic particles and the resin coating layer on the surface of the magnetic particles, in which inorganic particles are provided on a surface of the electrostatic charge image developing carrier or contained in the resin coating layer, and the inorganic particles contain Ti and any one of Ca, Sr, or Ba.

The inorganic particles may be provided on the surface of the carrier or may be contained in the resin coating layer, but from the viewpoint of line density and white spot suppression property of an image to be obtained, for example, it is preferable that the inorganic particles are provided on the surface of the carrier.

In addition, in a case where the inorganic particles are provided on the surface of the carrier, the inorganic particles may be externally added and attached to the surface of the carrier, or the inorganic particles in an amount that is liberated to the toner may be externally added and transferred to the carrier during the production of the electrostatic charge image developer.

Examples of the inorganic particles include calcium titanate particles, strontium titanate particles, and barium titanate particles.

Among these, from the viewpoint of line density and white spot suppression property of an image to be obtained, for example, strontium titanate particles are particularly preferable.

In addition, from the viewpoint of line density and white spot suppression property of an image to be obtained, for example, the inorganic particles preferably contain Ti and Sr.

In the above-described inorganic particles, from the viewpoint of line density and white spot suppression property of an image to be obtained, a value of a ratio Mx/Mt of a total molar amount Mx of Ca, Sr, and Ba to a molar amount Mt of Ti is, for example, preferably 0.60 or more and 0.95 or less, more preferably 0.65 or more and 0.90 or less, and particularly preferably 0.75 or more and 0.85 or less.

A method for measuring Mx/Mt in the present exemplary embodiment is as follows.

Each element on the carrier is mapped by energy dispersive X-ray analysis (SEM-EDX). A titanate compound is identified from the elements of each particle on the carrier, and a coverage is calculated.

Furthermore, a net intensity is measured by SEM-EDX, and the net intensity ratio of particles in which Ti and Ca/Sr/Ba are synchronized is calculated.

A calibration curve is separately created, and the molar conversion is carried out to obtain molar amounts (Mt and Mx), and Mx/Mt is calculated.

From the viewpoint of line density and white spot suppression property of an image to be obtained, an average primary particle size of the inorganic particles is, for example, preferably 10 nm or more and 100 nm or less, more preferably 20 nm or more and 90 nm or less, still more preferably 30 nm or more and 80 nm or less, and particularly preferably 30 nm or more and 60 nm or less.

In the present exemplary embodiment, the primary particle size of the inorganic particles is a diameter of a circle having the same area as the primary particle image (so-called equivalent circle diameter), and the average primary particle size of the inorganic particles is a particle size at which a cumulative percentage from the small diameter side in the number-based distribution of the primary particle diameters is 50%. The primary particle size of the inorganic particles is determined by performing image analysis on at least 300 inorganic particles. The above-described inorganic particles refer to particles present on the surface of the carrier from which a toner is removed by air blowing using any mesh from an electrostatic charge image developer. In addition, in above-described the inorganic fine particles, each element on the carrier is mapped by energy dispersive X-ray analysis (SEM-EDX), and a titanate compound is identified from the elements of each particle on the carrier.

The average primary particle size of the inorganic particles can be controlled, for example, by various conditions in a case where the inorganic particles are produced by a wet method.

In the present exemplary embodiment, the shape of the inorganic particles is not particularly limited, but from the viewpoint of suppressing occurrence of fogging, for example, it is preferable that the shape is rounded rather than a cube or a rectangular parallelepiped.

The circularity at which the cumulative percentage of the inorganic particles reaches 84% is a circularity at which the cumulative proportion of the primary particles reaches 84%. From the viewpoint of narrow number distribution of the circularity, difficulty of uneven attachment to the carrier, and line density and white spot suppression property of an image to be obtained, the above-described circularity is, for example, preferably more than 0.92, more preferably 0.93 or more, and particularly preferably 0.95 or more.

In regard to the inorganic particles, the circularity at which the cumulative percentage of the primary particles reaches 84% is one of indicators of the rounded shape, and it can be said that the shape is rounded in a case where the value is more than 0.92.

In the present exemplary embodiment, for example, it is preferable that the inorganic particles are doped with a metal element (hereinafter, also referred to as a dopant) other than the titanium, calcium, strontium, and barium. By containing the dopant, the inorganic particles have a perovskite structure with a reduced crystallinity and a rounded shape.

The dopant of the inorganic particles is not particularly limited as long as it is an element other than the titanium, calcium, strontium, and barium. In a case of being ionized, for example, an element having an ionic radius that can enter a crystal structure constituting the inorganic particles is preferable. From the viewpoint, the dopant of the inorganic particles is an element having an ionic radius of, for example, preferably 40 pm or more and 200 pm or less and more preferably 60 pm or more and 150 pm or less, in a case of being ionized.

Specifically, examples of the dopant of the inorganic particles include lanthanoid, silica (silicon), aluminum, magnesium, calcium, barium, phosphorus, sulfur, vanadium, chromium, manganese, iron, cobalt, nickel, copper, gallium, yttrium, zinc, niobium, molybdenum, ruthenium, rhodium, palladium, silver, indium, tin, antimony, tantalum, tungsten, rhenium, osmium, iridium, platinum, and bismuth. As lanthanoid, for example, lanthanum or cerium is preferable. Among these, from the viewpoint of line density and white spot suppression property of an image to be obtained, for example, silica or lanthanum is preferable.

As the dopant of the inorganic particles, from the viewpoint of not excessively negatively charging the inorganic particles, for example, an element having an electronegativity of 2.0 or less is preferable. The electronegativity in the present exemplary embodiment is Allred-Rochow electronegativity. Examples of the element having an electronegativity of 2.0 or less include lanthanum (electronegativity: 1.08), magnesium (1.23), aluminum (1.47), silica (1.74), calcium (1.04), vanadium (1.45), chromium (1.56), manganese (1.60), iron (1.64), cobalt (1.70), nickel (1.75), copper (1.75), zinc (1.66), gallium (1.82), yttrium (1.11), zirconium (1.22), niobium (1.23), silver (1.42), indium (1.49), tin (1.72), barium (0.97), tantalum (1.33), rhenium (1.46), and cerium (1.06).

From the viewpoint of having a rounded shape while having a perovskite-type crystal structure, an amount of the dopant in the inorganic particles is, for example, preferably in a range of 0.1 mol % or more and 20 mol % or less, more preferably in a range of 0.1 mol % or more and 15 mol % or less, and still more preferably in a range of 0.1 mol % or more and 10 mol % or less with respect to calcium, strontium, and barium.

In the present exemplary embodiment, from the viewpoint of improving the action of the inorganic particles, the inorganic particles are, for example, preferably inorganic particles having a surface subjected to a hydrophobization treatment. It is presumed that the hydrophobized inorganic particles repel each other on the resin-coated magnetic particles, and are easily dispersed with high uniformity.

In the present exemplary embodiment, the inorganic particles are, for example, more preferably inorganic particles having a surface hydrophobized by a silicon-containing organic compound. The inorganic particles hydrophobized with a silicon-containing organic compound are less likely to be liberated into a non-image area on a photoreceptor and are less likely to cause image defects, compared to inorganic particles hydrophobized with a strongly positively charged treatment agent such as a fatty acid metal salt.

For example, the inorganic particles preferably have a surface containing the silicon-containing organic compound in an amount of 1% by mass or more and 50% by mass or less (for example, preferably 5% by mass or more and 40% by mass or less, more preferably 5% by mass or more and 30% by mass or less, and still more preferably 10% by mass or more and 25% by mass or less) with respect to the mass of the inorganic particles.

That is, the hydrophobization treatment amount with the silicon-containing organic compound is, for example, preferably 1% by mass or more and 50% by mass or less, more preferably 5% by mass or more and 40% by mass or less, still more preferably 5% by mass or more and 30% by mass or less, and even more preferably 10% by mass or more and 25% by mass or less with respect to the mass of the inorganic particles.

In a case where the hydrophobization treatment amount is within the above-described range, it is easy to suppress the occurrence of fogging. In a case where the hydrophobization treatment amount is 30% by mass or less, generation of aggregates due to the hydrophobized surface is suppressed.

In the present exemplary embodiment, for example, the inorganic particles preferably have a moisture content of 1.5% by mass or more and 10% by mass or less. In a case where the moisture content is 1.5% by mass or more and 10% by mass or less (for example, more preferably 2% by mass or more and 5% by mass or less), the resistance of the inorganic particles is controlled in an appropriate range, and the uneven distribution due to the electrostatic repulsion between the inorganic particles is suppressed. The moisture content of the inorganic particles can be controlled, for example, by producing the inorganic particles by a wet method and adjusting a temperature and time of the drying treatment. In a case where the hydrophobization treatment is performed on the inorganic particles, the moisture content of the inorganic particles can be controlled by adjusting the temperature and time of the drying treatment after the hydrophobization treatment.

The moisture content of the inorganic particles is measured as follows.

20 mg of a measurement sample is left to stand for 17 hours in a chamber at a temperature of 22° C./a relative humidity of 55% such that the sample is humidified. Thereafter, in a room at a temperature of 22° C./a relative humidity of 55%, by a thermobalance (TGA-50 manufactured by Shimadzu Corporation.), the sample is heated from 30° C. to 250° C. at a temperature rise rate of 30° C./min in nitrogen gas atmosphere, and a loss on heating (loss of mass caused by heating) is measured. Based on the measured loss on heating, the moisture content is calculated by the following equation.

$$Moisture content ( \% by mass ) = ( Loss on heating from 30 ° C . to 250 ° C . ) \div ( Mass of humidified sample before being heated ) \times 100$$

A content of the inorganic particles contained in the electrostatic charge image developing carrier according to the present exemplary embodiment is, for example, preferably 0.01% by mass or more and 0.8% by mass or less, more preferably 0.01% by mass or more and 0.5% by mass or less, still more preferably 0.02% by mass or more and 0.08% by mass or less, and even still more preferably 0.04% by mass or more and 0.05% by mass or less with respect to the total mass of the carrier.

The inorganic particles may be the inorganic particles themselves or may be particles obtained by performing a hydrophobic treatment on a surface of the inorganic particles (may be referred to as “base particles”). A method for producing the inorganic particles (base particles) is not particularly limited, but from the viewpoint of controlling the particle size and the shape, for example, a wet method is preferable.

The wet method of the inorganic particles is, for example, a production method of causing a reaction in a state of adding an alkaline aqueous solution to a mixed solution of a titanium oxide source and a source of calcium, strontium, or barium, and then performing an acid treatment. In the present production method, the particle size of the inorganic particles is controlled by a mixing proportion of the titanium oxide source and the source of calcium, strontium, or barium, the concentration of the titanium oxide source at the initial state of reaction, the temperature during the addition of the alkaline aqueous solution, the addition rate of the alkaline aqueous solution, and the like.

The surface treatment of the inorganic particles is performed, for example, by preparing a treatment liquid obtained by mixing the silicon-containing organic compound that is a hydrophobizing treatment agent with a solvent, mixing the inorganic particles with the treatment liquid under stirring, and further continuing the stirring. After the surface treatment, for the purpose of removing the solvent in the treatment liquid, a drying treatment is performed.

Examples of the silicon-containing organic compound used in the surface treatment for the inorganic particles include an alkoxysilane compound, a silazane compound, and a silicone oil.

Examples of the alkoxysilane compound used in the surface treatment for the inorganic particles include tetramethoxysilane, tetraethoxysilane; methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, vinyltriethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane; dimethyldimethoxysilane, dimethyldiethoxysilane, methylvinyldimethoxysilane, methylvinyldiethoxysilane, diphenyldimethoxysilane, diphenyldiethoxysilane; and trimethylmethoxysilane and trimethylethoxysilane.

Examples of the silazane compound used in the surface treatment for the inorganic particles include dimethyldisilazane, trimethyldisilazane, tetramethyldisilazane, pentamethyldisilazane, and hexamethyldisilazane.

Examples of the silicone oil used in the surface treatment for the inorganic particles include silicone oils such as dimethylpolysiloxane, diphenylpolysiloxane, and phenylmethylpolysiloxane; and reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

The solvent used for preparing the above-described treatment liquid is, for example, preferably an alcohol (for example, methanol, ethanol, propanol, or butanol) in a case where the silicon-containing organic compound is an alkoxysilane compound or a silazane compound, or preferably hydrocarbons (for example, benzene, toluene, normal hexane, and normal heptane) in a case where the silicon-containing organic compound is a silicone oil.

In the above-described treatment liquid, a concentration of the silicon-containing organic compound is, for example, preferably 1% by mass or more and 50% by mass or less, more preferably 5% by mass or more and 40% by mass or less, and still more preferably 10% by mass or more and 30% by mass or less.

The amount of the silicon-containing organic compound used in the surface treatment is, for example, preferably 1 part by mass or more and 50 parts by mass or less, more preferably 5 parts by mass or more and 40 parts by mass or less, and still more preferably 5 parts by mass or more and 30 parts by mass or less with respect to 100 parts by mass of the inorganic particles.

### Magnetic Particles

The magnetic particles are not particularly limited, and known magnetic particles used as a core material of the carrier are applied. Specific examples of the magnetic particles include particles of a magnetic metal such as iron, nickel, and cobalt; particles of a magnetic oxide such as ferrite and magnetite; resin-impregnated magnetic particles in which a porous magnetic powder is impregnated with a resin; and magnetic powder-dispersed resin particles in which a magnetic powder is dispersed in a resin.

As the magnetic particles in the present exemplary embodiment, for example, ferrite particles are suitable.

In the present exemplary embodiment, for example, it is preferable that the ferrite particles contain at least one compound selected from calcium oxide and strontium oxide. It is presumed that calcium oxide and strontium oxide are likely to be contained in the surface of the ferrite particles, and in a case where a calcium element or a strontium element is present within the surface of the ferrite particles, leakage of charge from the ferrite particles may be suppressed, that may allow the carrier surface to be charged to a high level. Such a carrier inhibits a toner from being charged to a low level in a developing device. As a result, the fogging is further suppressed, and fine line reproducibility is improved (for example, thickening, crushing, or blurring of fine lines is suppressed). The present effect is markedly exhibited in a case where high-concentration and high-density monochromatic images are repeatedly formed at a high speed and then low-density images of the same color are formed.

In the present exemplary embodiment, for example, the ferrite particles preferably contain at least one compound selected from calcium oxide and strontium oxide, and the total content of a calcium element and a strontium element is, for example, preferably 0.1% by mass or more and 2.0% by mass or less with respect to the total mass of the ferrite particles. In a case where the total content of the calcium element and the strontium element is 0.1% by mass or more with respect to the entire ferrite particles, charge leakage from the ferrite particles is efficiently suppressed. In a case where the total content of the calcium element and the strontium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed). From the above-described viewpoint, the total content of the calcium element and the strontium element with respect to the entire ferrite particles is, for example, preferably 0.1% by mass or more and 2.0% by mass or less, more preferably 0.2% by mass or more and 1.5% by mass or less, and still more preferably 0.5% by mass or more and 1.2% by mass or less.

In the present exemplary embodiment, the ferrite particles contain calcium oxide, and a content of the calcium element is, for example, preferably 0.2% by mass or more and 2.0% by mass or less with respect to the total mass of the ferrite particles. In a case where the content of the calcium element is 0.2% by mass or more with respect to the entire ferrite particles, the charge leakage from the ferrite particles is efficiently suppressed. In a case where the total content of the calcium element is 2.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the calcium element with respect to the entire ferrite particles is, for example, preferably 0.2% by mass or more and 2.0% by mass or less, more preferably 0.5% by mass or more and 1.5% by mass or less, and still more preferably 0.5% by mass or more and 1.0% by mass or less.

In the present exemplary embodiment, the ferrite particles contain strontium oxide, and a content of the strontium element is, for example, preferably 0.1% by mass or more and 1.0% by mass or less with respect to the total mass of the ferrite particles. In a case where the content of the strontium element is 0.1% by mass or more with respect to the entire ferrite particles, the charge leakage from the ferrite particles is efficiently suppressed. In a case where the total content of the strontium element is 1.0% by mass or less with respect to the entire ferrite particles, the crystal structure of the ferrite particles is organized, and the resistance and magnetic susceptibility are in an appropriate range. As a result, the fogging is further suppressed, and fine line reproducibility is improved (for example, thickening, crushing, or blurring of fine lines is suppressed).

From the above-described viewpoint, the content of the strontium element with respect to the entire ferrite particles is, for example, preferably 0.1% by mass or more and 1.0% by mass or less, more preferably 0.4% by mass or more and 1.0% by mass or less, and still more preferably 0.5% by mass or more and 0.8% by mass or less.

The contents of the calcium element and the strontium element contained in the ferrite particles are measured by X-ray fluorescence analysis. The X-ray fluorescence analysis is performed on the ferrite particles by the following method.

Using an X-ray fluorescence spectrometer (manufactured by Shimadzu Corporation., XRF1500) under the conditions of X-ray output: 40 V/70 mA, measurement area: diameter of 10 mm, and measurement time: 15 minutes, qualitative analysis and quantitative analysis are performed. The element to be analyzed is selected based on the element detected by the qualitative analysis. Iron (Fe), manganese (Mn), magnesium (Mg), calcium (Ca), strontium (Sr), oxygen (O), and carbon (C) are generally selected. A mass proportion (%) of each element is calculated with reference to the separately created calibration curve data.

A volume-average particle size of the magnetic particles is 10 μm or more and 500 μm or less, for example, preferably 20 μm or more and 180 μm or less, and more preferably 25 μm or more and 60 μm or less.

As for a magnetic force of the magnetic particles, a saturation magnetization of the magnetic particles in a magnetic field of 3,000 Oe is 50 emu/g or more, for example, preferably 60 emu/g or more. The saturation magnetization is measured using a vibrating sample magnetometer VSMP10-15 (manufactured by TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the magnetic particles is 10⁵ Ω·cm or more and 10⁹ Ω·cm or less, for example, preferably 10⁷ Ω·cm or more and 10⁹ Ω·cm or less.

The electrical volume resistance (Ω·cm) of the magnetic particles is measured as follows. A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 103.8 V/cm is generated, and the current value (A) flowing at this time is read. The volume resistivity is measured in an environment at a temperature of 20° C. and a humidity of 50% RH. An expression for calculating the electrical volume resistance (Ω·cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

### Resin Coating Layer

The electrostatic charge image developing carrier according to the present exemplary embodiment has a resin coating layer on the surface of the magnetic particles described above.

Examples of the resin configuring the resin coating layer include a styrene acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof, a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

From the viewpoint of linear density of an image to be obtained, for example, the above-described resin coating layer preferably contains an acrylic resin having an aliphatic cyclic structure and an amino group, and more preferably contains an acrylic resin that has a constitutional unit having an aliphatic cyclic structure and a constitutional unit having an amino group.

Preferred examples of the aliphatic cyclic structure include a cycloalkyl group, and more preferred examples thereof include a cyclohexyl group. Since the charge amount of the acrylic resin having an aliphatic cyclic structure is less likely to change with a change in temperature and humidity, the line density in the image to be obtained is stable. In particular, for example, a cyclohexyl group that is stable and has a large functional group in a 6-membered ring is preferable. In addition, the acrylic resin having a cyclohexyl group is less likely to cause a local difference in charge on the carrier surface, so that the uneven distribution of the inorganic particles is less likely to occur, and the line density is more stable.

Specific examples of the acrylic resin having a cyclohexyl group include a homopolymer of an acrylic monomer having a cyclohexyl group and a copolymer of an acrylic monomer having a cyclohexyl group and another monomer.

Examples of the acrylic monomer having a cyclohexyl group include cyclohexyl acrylate and cyclohexyl methacrylate.

In addition, examples of the constitutional unit having an aliphatic cyclic structure include a constitutional unit derived from cyclohexyl (meth)acrylate.

From the viewpoint of line density of an image to be obtained, for example, the acrylic resin that has a constitutional unit having an aliphatic cyclic structure preferably contains 80% by mass or more of the constitutional unit having an aliphatic cyclic structure.

In addition, preferred examples of the acrylic monomer having an amino group include dialkylaminoalkyl (meth)acrylate, and more preferred examples thereof include dimethylaminoethyl (meth)acrylate.

From the viewpoint of line density of an image to be obtained, for example, the acrylic resin that has a constitutional unit having an amino group preferably contains 0.05% by mass or more and 5% by mass or less of the constitutional unit having an amino group, and more preferably contains 0.1% by mass or more and 3% by mass or less of the constitutional unit having an amino group.

For example, the acrylic resin having an amino group preferably has a stable line density in terms of the charging properties under high humidity. As the acrylic monomer having an amino group, for example, dimethylaminoethyl (meth)acrylate is particularly preferable because the difference in charge between low humidity and high humidity is small.

In a case of containing the acrylic resin that has a constitutional unit having an aliphatic cyclic structure and a constitutional unit having an amino group, the line density is more likely to be stable. This is because, by using the combination, the relatively large aliphatic cyclic structure portion is present around the amino group portion, so that the amino group is less likely to be affected by moisture, the charge can be maintained, and the inorganic fine particles are likely to be present on the carrier surface. At the same time, the affinity of the aliphatic cyclic structure portion with the inorganic fine particles interposed with moisture is suppressed, so that the excessive adhesion of the inorganic fine particles to the carrier can be suppressed, and the line density is stabilized. From the size of the structure, for example, a combination of cyclohexyl acrylate and dimethylamino (meth)acrylate is more preferable.

The resin coating layer may contain inorganic particles other than the inorganic particles containing Ti and any of Ca, Sr, or Ba described above for the purpose of controlling charging or resistance. Examples of the inorganic particles include carbon black; metals such as gold, silver, and copper; metal compounds such as barium sulfate, aluminum borate, potassium titanate, titanium oxide, silica, zinc oxide, tin oxide, antimony-doped tin oxide, indium-doped tin oxide, and zinc oxide-doped aluminum; and resin particles coated with a metal.

Among these, as the inorganic particles other than the inorganic particles containing Ti and any of Ca, Sr, or Ba described above, silica particles are preferable.

A content of the inorganic particles other than the inorganic particles containing Ti and any of Ca, Sr, or Ba described above is, for example, preferably 15% by mass or more and 50% by mass or less, and more preferably 20% by mass or more and 40% by mass or less with respect to the total mass of the resin coating layer.

In a case where the thickness of the resin coating layer is within the above-described range, the transfer of other toner external additives to the resin coating layer, that reduces the effect of the inorganic particles containing Ti and any of Ca, Sr, or Ba described above, is suppressed. In addition, by using the silica particles, the transfer of other toner external additives to the resin coating layer is further suppressed.

Examples of a method of forming the resin coating layer on the surface of the magnetic particles include a wet manufacturing method and a dry manufacturing method. The wet manufacturing method is a manufacturing method using a solvent that dissolves or disperses the resin configuring the resin coating layer. On the other hand, the dry manufacturing method is a manufacturing method that does not use the above-described solvent.

Specifically, examples of the wet manufacturing method include a dipping method of dipping the magnetic particles in a resin solution for forming a resin coating layer; a spray method of spraying the resin solution for forming a resin coating layer to the surface of the magnetic particles; a fluidized bed method of spraying the resin solution for forming a resin coating layer to the magnetic particles that are in a state of being fluidized in a fluidized bed; and a kneader coater method of mixing the magnetic particles with the resin solution for forming a resin coating layer in a kneader coater and removing solvents.

The resin solution for forming the resin coating layer used in the wet manufacturing method is prepared by dissolving or dispersing a resin and other components in a solvent. The solvent is not particularly limited as long as the solvent dissolves or disperses the resin, and for example, aromatic hydrocarbons such as toluene and xylene; ketones such as acetone and methyl ethyl ketone; ethers such as tetrahydrofuran and dioxane; and the like are used.

Examples of the dry manufacturing method include a method of heating a mixture of the magnetic particles and a resin for forming a resin coating layer in a dry state to form the resin coating layer. Specifically, for example, the magnetic particles and the resin for forming a resin coating layer are mixed together in a gas phase and melted by heating to form the resin coating layer.

A thickness of the resin coating layer is, for example, preferably 0.1 μm or more and μm or less, and more preferably 0.3 μm or more and 5 μm or less.

An exposed proportion of the magnetic particles on the surface of the carrier is, for example, preferably 2% or more and 20% or less, more preferably 2% or more and 10% or less, and still more preferably 3% or more and 8% or less.

The exposed proportion of the magnetic particles on the surface of the carrier is determined by an X-ray photoelectron spectroscopy (XPS) from the following method.

A target carrier and magnetic particles obtained by removing the resin coating layer from the target carrier are prepared. Examples of a method of removing the resin coating layer from the resin-coated magnetic particles include a method of removing the resin coating layer by dissolving resin components with an organic solvent, and a method of removing the resin coating layer by heating the carrier to approximately 800° C. to eliminate the resin components. The carrier and the magnetic particles excluding the resin coating layer are each used as a measurement sample, Fe (atomic %) is quantified by XPS, and (Fe of resin-coated magnetic particles)+(Fe of magnetic particles)×100 is calculated to obtain the exposed proportion (%) of the magnetic particles.

The exposed proportion of the magnetic particles on the surface of the carrier can be controlled by the amount of the resin used for forming the resin coating layer, and as the amount of the resin relative to the amount of the magnetic particles is larger, the exposed proportion is smaller.

### Characteristics of Carrier

A volume-average particle size of the carrier is, for example, preferably 15 μm or more and 510 μm or less, more preferably 20 μm or more and 180 μm or less, and still more preferably 25 μm or more and 60 μm or less.

From the viewpoint of line density of an image to be obtained, a fluidity of the electrostatic charge image developing carrier in the present exemplary embodiment is, for example, preferably 26 or more and 34 or less, more preferably 27 or more and 33 or less, and particularly preferably 29 or more and 31 or less. A unit of the fluidity is sec/50 g unless otherwise specified.

The fluidity of the electrostatic charge image developing carrier in the present exemplary embodiment is a value measured at 25° C. and 50% RH according to JIS Z 2502 (2020).

As for a magnetic force of the carrier, a saturation magnetization of the carrier in a magnetic field of 1,000 Oe is 40 emu/g or more, for example, preferably 50 emu/g or more. The measurement of the saturation magnetization described above is performed by sweeping up to a maximum of 1,000 Oe in the same manner as the measurement of the saturation magnetization of the magnetic particles.

A volume electrical resistance (25° C.) of the carrier is 1×10⁷ Ω·cm or more and 1×10¹⁵ Ω·cm or less, for example, preferably 1×10⁸ Ω·cm or more and 1×10¹⁴ Ω·cm or less and more preferably 1×10⁸ Ω·cm or more and 1×10¹³ Ω·cm or less. The measurement of the volume electrical resistance of the carrier is performed in the same manner as the measurement of the volume electrical resistance of the magnetic particles.

### Electrostatic Charge Image Developer

The developer according to the present exemplary embodiment contains a toner and the carrier according to the present exemplary embodiment.

The developer according to the present exemplary embodiment is prepared by mixing the toner and the carrier according to the present exemplary embodiment at an appropriate formulation proportion. The mixing ratio (mass ratio) between the toner and the carrier, represented by toner:carrier, is, for example, preferably 1:100 to 30:100, and more preferably 3:100 to 20:100.

### Electrostatic Charge Image Developing Toner

As the toner, known toners are used without particular restriction. Examples thereof include a colored toner that contains toner particles containing a binder resin and a colorant, and an infrared-absorbing toner that uses an infrared absorber instead of a colorant. The toner may contain a release agent, various internal additives, external additives, and the like.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable. Examples of the polyester resin include known polyester resins.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less. The number-average molecular weight (Mn) of the polyester resin is, for example, preferably 2,000 or more and 100,000 or less. The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

For example, it is also preferable to use a polyester resin and a vinyl resin in combination, as the binder resin. The combination may be a hybrid resin (so-called styrene acrylic-modified polyester resin) in which a vinyl resin segment and a polyester resin segment are chemically bonded, or a mixed resin in which vinyl resin fine particles are mixed with a polyester resin.

In a case where the polyester resin and the vinyl resin are used in combination, the line density in the image is more stable. This is because the presence of the vinyl resin, that is slower to melt than the polyester, prevents the thin line from being thick and stabilizes the concentration in a case where the polyester component of the toner particles transferred onto the paper during fixing is melted to form an image.

Examples of the vinyl resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

One kind of each of these vinyl resins may be used alone, or two or more kinds of these vinyl resins may be used in combination.

As the vinyl resin, for example, a styrene acrylic resin is preferable due to the incompatibility with the polyester resin during toner melting.

The styrene acrylic resin is a copolymer obtained by copolymerizing at least a styrene-based monomer (a monomer having a styrene skeleton) and a (meth)acrylic monomer (a monomer containing a (meth)acryloyl group and, for example, preferably a monomer containing a (meth)acryloyloxy group). The styrene acrylic resin includes, for example, a copolymer of a monomer of styrenes and a monomer of (meth)acrylic acid esters described above. The acrylic resin portion in the styrene acrylic resin is any one of an acrylic monomer or a methacrylic monomer, or a partial structure obtained by polymerizing the monomers. In addition, “(meth)acrylic” is an expression including both of “acrylic” and “methacrylic”.

Specific examples of the styrene-based monomer include styrene, alkyl-substituted styrene (such as α-methylstyrene, 2-methylstyrene, 3-methylstyrene, 4-methylstyrene, 2-ethylstyrene, 3-ethylstyrene, and 4-ethylstyrene), halogen-substituted styrene (such as 2-chlorostyrene, 3-chlorostyrene, and 4-chlorostyrene), and vinylnaphthalene. The styrene-based monomer may be used alone or in combination of two or more kinds thereof.

Among these, from the viewpoint of ease of reaction, ease of control of reaction, and availability, as the styrene-based monomer, for example, styrene is preferable.

Specific examples of the (meth)acrylic monomer include (meth)acrylic acid and (meth)acrylic acid ester. Examples of the (meth)acrylic acid ester include (meth)acrylic acid alkyl ester (such as methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, and t-butylcyclohexyl (meth)acrylate), (meth)acrylic acid aryl ester (such as phenyl (meth)acrylate, biphenyl (meth)acrylate, diphenylethyl (meth)acrylate, t-butylphenyl (meth)acrylate, and terphenyl (meth)acrylate); dimethylaminoethyl (meth)acrylate, diethylaminoethyl (meth)acrylate, methoxyethyl (meth)acrylate, 2-hydroxyethyl (meth)acrylate, β-carboxylethyl (meth)acrylate, and (meth)acrylamide. The (meth)acrylic monomer may be used alone or in combination of two or more kinds thereof. Among the (meth)acrylic monomers, from the viewpoint of improving the fixability of the toner, for example, (meth)acrylic acid ester containing an alkyl group having 2 or more and 14 or less carbon atoms (for example, preferably 2 or more and 10 or less carbon atoms and more preferably 3 or more and 8 or less carbon atoms) is preferable among the (meth)acrylic esters. Among these, for example, n-butyl (meth)acrylate is preferable, and n-butyl acrylate is particularly preferable.

The copolymerization ratio of the styrene-based monomer to the (meth)acrylic monomer (on a mass basis, styrene-based monomer/(meth)acrylic monomer) is not particularly limited, but is preferably 98/2 to 60/40.

From the viewpoint of improving the fixability of the toner, the glass transition temperature (Tg) of the styrene acrylic resin is, for example, preferably 40° C. or higher and 75° C. or lower, and more preferably 50° C. or higher and 65° C. or lower.

Here, the glass transition temperature of the resin is determined from a DSC curve obtained by the differential scanning calorimetry (DSC). More specifically, the glass transition temperature of the resin is determined by “extrapolated glass transition onset temperature” described in the method for determining a glass transition temperature in JIS K 7121: 1987, “Testing methods for transition temperatures of plastics”.

The weight-average molecular weight and the number-average molecular weight of the styrene acrylic resin are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

A method of producing the styrene acrylic resin is not particularly limited, and various polymerization methods (for example, solution polymerization, precipitation polymerization, suspension polymerization, bulk polymerization, and emulsion polymerization) are applied. In addition, a known operation (for example, a batch type, semi-continuous type, or continuous type operation) is applied to the polymerization reaction.

The content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye; and inorganic pigments such as a titanium compounds, silica, and aluminum.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

A content of the colorant is, for example, preferably 1% by mass or more and 30% by mass or less and more preferably 3% by mass or more and 15% by mass or less with respect to the total amount of the toner particles.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, a charge control agent, and inorganic powder. The additives are incorporated into the toner particles as internal additives.

### Characteristics of Toner Particles and the Like

The toner particles may be toner particles that have a single-layer structure or toner particles having a so-called core/shell structure that is configured with a core portion (core particle) and a coating layer (shell layer) coating the core portion. The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The volume-average particle size (D50v) of the toner particles is measured using COULTER MULTISIZER II (manufactured by Beckman Coulter, Inc.) and using ISOTON-II (manufactured by Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO SiO₂, K₂O·(TiO₂)ₙ, Al₂O₃·2SiO₂, CaCO₃, MgCO₃, BaSO₄, MgSO₄, SrTiO₃, BaTiO₃, and CaTiO₃.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobic agent is, for example, preferably 1 part by mass or more and 10 parts by mass or less with respect to 100 parts by mass of the inorganic particles.

Examples of the external additive also include resin particles (resin particles such as polystyrene, polymethylmethacrylate, and melamine resins), a cleaning activator (for example, metal salts of a higher fatty acid represented by zinc stearate, particles of a fluorine-based polymer, and higher alcohols).

The amount of the external additive externally added with respect to the toner particles is, for example, preferably 0.01% by mass or more and 10% by mass or less, and more preferably 0.01% by mass or more and 6.0% by mass or less.

### Manufacturing Method of Toner

The toner is obtained by manufacturing toner particles and then externally adding external additives to the toner particles. The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

### Image Forming Apparatus and Image Forming Method

The image forming apparatus and image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed that has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralization unit that neutralizes charge by irradiating the surface of the image holder with charge neutralizing light before charging after the transfer of the toner image.

In the case where the image forming apparatus according to the present exemplary embodiment is the intermediate transfer-type apparatus, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) detachable from the image forming apparatus. As the process cartridge, for example, a process cartridge is suitably used that includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawings, main parts will be described, and others will not be described.

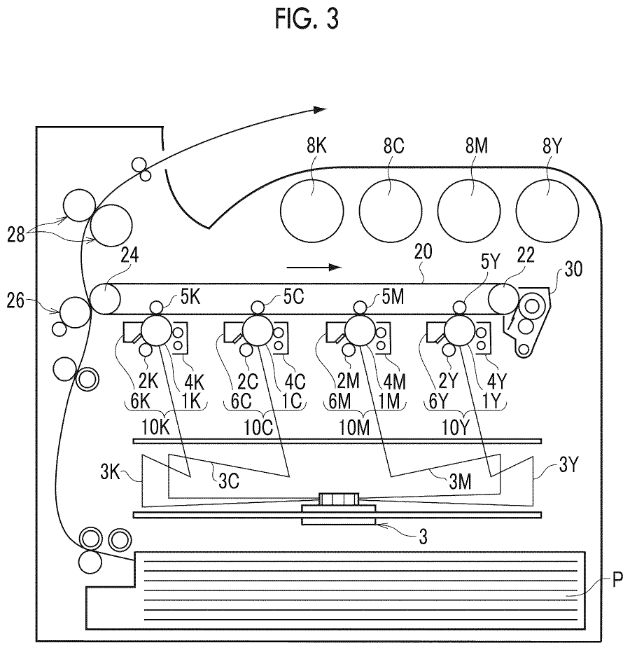

FIG. 3 is a view schematically showing the configuration of the image forming apparatus according to the present exemplary embodiment.

The image forming apparatus shown in FIG. 3 includes first to fourth image forming units 10Y, 10M, 10C, and 10K (image forming means) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of the intermediate transfer member) 20 passing through above the units 10Y, 10M, 10C, and 10K extends under the units. The intermediate transfer belt 20 is looped around a driving roll 22 and a support roll 24, and runs toward the fourth unit 10K from the first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the image holding surface side of the intermediate transfer belt 20.

Yellow, magenta, cyan, and black toners contained in containers of toner cartridges 8Y, 8M, 8C, and 8K are supplied to developing devices (developing units) 4Y, 4M, 4C, and 4K of the units 10Y, 10M, 10C, and 10K, respectively.

The first to fourth units 10Y, 10M, 10C, and 10K have the same configuration and operation. Therefore, in the present specification, as a representative, the first unit 10Y will be d escribed which is placed on the upstream side of the running direction of the intermediate transfer belt and forms a yellow image.

The first unit 10Y has a photoreceptor 1Y that acts as an image holder. Around the photoreceptor 1Y, a charging roll (an example of the charging unit) 2Y that charges the surface of the photoreceptor 1Y at a predetermined potential, an exposure device (an example of the electrostatic charge image forming unit) 3 that exposes the charged surface to a laser beam 3Y based on color-separated image signals to form an electrostatic charge image, a developing device (an example of the developing unit) 4Y that develops the electrostatic charge image by supplying a charged toner to the electrostatic charge image, a primary transfer roll 5Y (an example of the primary transfer unit) that transfers the developed toner image onto the intermediate transfer belt 20, and a photoreceptor cleaning device (an example of the cleaning unit) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y A bias power supply (not shown in the drawing) for applying a primary transfer bias is connected to primary transfer rolls 5Y, 5M, 5C, and 5K of each unit. Each bias power supply changes the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. From the exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

On the other hand, the residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt 20, and a secondary transfer roll 26 (an example of a secondary transfer unit) disposed on the image holding surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

### Process Cartridge

The process cartridge according to the present exemplary embodiment will be described.

The process cartridge according to the present exemplary embodiment includes a developing unit that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing unit and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawings, main parts will be described, and others will not be described.

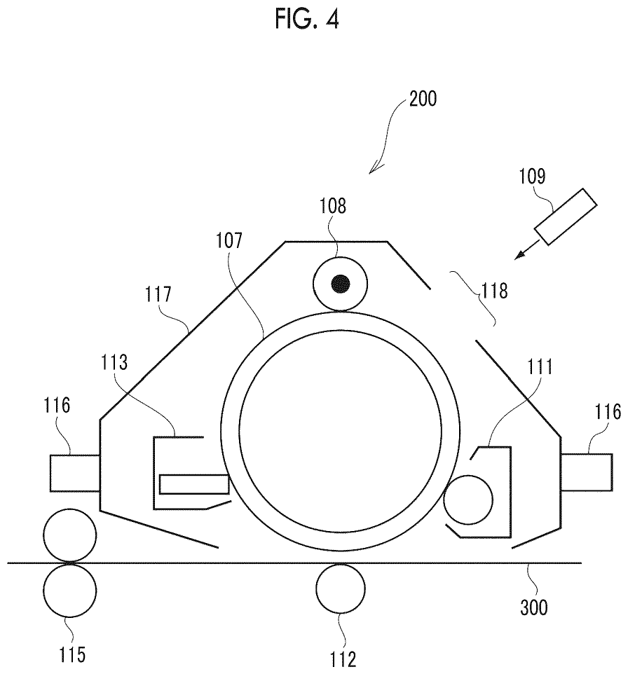

FIG. 4 is a view schematically showing the configuration of the process cartridge according to the present exemplary embodiment.

A process cartridge 200 shown in FIG. 4 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), that are integrally combined and held in the housing 117. The process cartridge 200 forms a cartridge in this way.

In FIG. 4, 109 represents an exposure device (an example of electrostatic charge image forming unit), 112 represents a transfer device (an example of transfer unit), 115 represents a fixing device (an example of fixing unit), and 300 represents recording paper (an example of recording medium).

### EXAMPLES

Hereinafter, the present exemplary embodiments will be specifically described based on Examples. However, the present exemplary embodiments are not limited to Examples. In the following description, unless otherwise specified, “parts” and “%” are based on mass.

### Measurement of BET Specific Surface Area of Magnetic Particles

The toner is removed from the electrostatic charge image developer by air blowing using any mesh. Thereafter, the coating film is removed with a solvent to obtain magnetic particles.

The obtained magnetic particles are placed in a cell of SA3100 specific surface area measuring device (manufactured by Beckman Coulter, Inc.), subjected to a deaeration treatment at 60° C. for 120 minutes, purged with a mixed gas of nitrogen and helium (volume ratio: 30:70), and measured by a continuous one-point method.

### Measurement of Circularity Distribution and Average Circularity of Inorganic Particles

The average circularity of the inorganic particles is obtained by performing image analysis on at least 300 inorganic particles to obtain a circularity, creating a circularity distribution, and calculating the average circularity. In addition, from the circularity distribution, the circularity of the inorganic particles at which a cumulative percentage reaches 84% is obtained. The above-described inorganic particles are particles present on a surface of a carrier from which a toner is removed by air blowing from an electrostatic charge image developer using any mesh, and the inorganic particles are identified and measured by mapping each element on the carrier by energy dispersive X-ray analysis (SEM-EDX) and identifying each particle on the carrier from the element.

### Measurement of Ratio Mx/Mt of Molar Amount Mt of Ti and Total Molar Amount Mx of Ca, Sr, and Ba

Each element on the carrier is mapped by energy dispersive X-ray analysis (SEM-EDX). A titanate compound is identified from the elements of each particle on the carrier, and a coverage is calculated.

Furthermore, a net intensity is measured by SEM-EDX, and the net intensity ratio of particles in which Ti and Ca/Sr/Ba are synchronized is calculated.

A calibration curve is separately created, and the molar conversion is carried out to obtain molar amounts (Mt and Mx), and Mx/Mt is calculated.

### Volume-Average Particle Size of Carrier

The toner is removed from the electrostatic charge image developer by air blowing using any mesh, and the carrier is taken out. The particle size distribution of the carrier is measured using a laser diffraction/scattering-type particle size distribution analyzer (LS Particle Size Analyzer; LS13 320, manufactured by Beckman Coulter, Inc.). For the particle size range (channel) obtained by dividing the obtained particle size distribution, a volume-based cumulative distribution is plotted from the small-sized particle side, and a particle size at which the cumulative percentage reaches 50% is adopted as the volume-average particle size D50.

### Production of Toner

### Preparation of Resin Particle Dispersion (1)

Ethylene glycol (manufactured by FUJIFILM Wako Pure Chemical Corporation): 37 parts
Neopentyl glycol (manufactured by FUJIFILM Wako Pure Chemical Corporation): 65 parts
1,9-Nonanediol (manufactured by FUJIFILM Wako Pure Chemical Corporation): 32 parts
Terephthalic acid (manufactured by FUJIFILM Wako Pure Chemical Corporation): 96 parts

The above-described materials are put in a flask, the temperature is raised to 200° C. for 1 hour, and after it is confirmed that the inside of the reaction system is uniformly agitated, 1.2 parts of dibutyltin oxide is added. The temperature is raised to 240° C. for 6 hours in a state where the generated water is distilled off, and stirring is continued at 240° C. for 4 hours, thereby obtaining a polyester resin (acid value: 9.4 mgKOH/g, weight-average molecular weight: 13,000, glass transition temperature: 62° C.). The polyester resin in a molten state is transferred to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining a resin particle dispersion (1) having a volume-average particle size of 160 nm and a solid content of 30%.

### Preparation of Resin Particle Dispersion (2)

Decanedioic acid (manufactured by Tokyo Chemical Industry Co., Ltd.): 81 parts
Hexandiol (manufactured by FUJIFILM Wako Pure Chemical Corporation): 47 parts

The above-described materials are put in a flask, the temperature is raised to 160° C. for 1 hour, and after it is confirmed that the inside of the reaction system is uniformly agitated, 0.03 parts of dibutyltin oxide is added. While the generated water is distilled off, the temperature is raised to 200° C. for 6 hours, and agitating is continued for 4 hours at 200° C. Thereafter, the reaction solution is cooled, solid-liquid separation is performed, and the solid is dried at a temperature of 40° C. under reduced pressure, thereby obtaining a polyester resin (C1) (melting point: 64° C., weight-average molecular weight: 15,000).
Polyester resin (C1): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 180 nm, the dispersed resultant is collected, thereby obtaining a resin particle dispersion (2) having a solid content of 20%.

### Preparation of Colorant Particle Dispersion (1)

Cyan pigment (PigmentBlue 15:3, manufactured by Dainichiseika Color & Chemicals Mfg. Co., Ltd.): 10 parts
Anionic surfactant (NEOGEN SC, manufactured by DKS Co. Ltd.): 2 parts
Deionized water: 80 parts

The above-described materials are mixed together and dispersed for 1 hour with a high-pressure impact disperser ULTIMIZER (HJP30006, manufactured by SUGINO MACHINE LIMITED), thereby obtaining a colorant particle dispersion (1) having a volume-average particle size of 180 nm and a solid content of 20%.

### Preparation of Release Agent Particle Dispersion (1)

Paraffin wax (HNP-9, manufactured by NIPPON SEIRO CO., LTD.): 50 parts
Anionic surfactant (NEOGEN SC, manufactured by DKS Co. Ltd.): 2 parts
Deionized water: 200 parts

The above-described materials are heated to 120° C., thoroughly dispersed with a homogenizer (ULTRA-TURRAX T50, IKA), and then subjected to a dispersion treatment with a pressure jet-type homogenizer. At a point in time when the volume-average particle size reaches 200 nm, the dispersed resultant is collected, thereby obtaining a release agent particle dispersion (1) having a solid content of 20%.

### Production of Toner (1)

Resin particle dispersion (1): 150 parts
Resin particle dispersion (2): 50 parts
Colorant particle dispersion (1): 25 parts
Release agent particle dispersion (1): 35 parts
Polyaluminum chloride: 0.4 parts
Deionized water: 100 parts

The above-described materials are put in a round stainless steel flask, thoroughly mixed and dispersed together by using a homogenizer (ULTRA-TURRAX T50, IKA), and then heated to 48° C. in an oil bath for heating in a state where the inside of the flask is stirred. The internal temperature of the reaction system is kept at 48° C. for 60 minutes, and then 70 parts of the resin particle dispersion (1) is slowly added thereto. Next, the pH is adjusted to 8.0 by using a 0.5 mol/L aqueous sodium hydroxide solution, the flask is then sealed, heated to 90° C. while being continuously stirred with a stirring shaft with a magnetic seal, and kept at 90° C. for 30 minutes. Next, the mixture is cooled at a cooling rate of 5° C./min, subjected to solid-liquid separation, and thoroughly washed with deionized water. Next, the mixture is subjected to solid-liquid separation, redispersed in deionized water at 30° C., and stirred and washed at a rotation speed of 300 rotations per minute (rpm) for 15 minutes. The washing operation is further repeated 6 times, solid-liquid separation is performed at a point in time when the pH of the filtrate reaches 7.54 and the electrical conductivity reaches 6.5 μS/cm, and vacuum drying is continued for 24 hours, thereby obtaining toner particles having a volume-average particle size of 5.7 μm.

100 parts of the above-described toner particles and 2.5 parts of silica particles (treated with hexamethyldisilazane for surface hydrophobization, average primary particle size: 40 nm) are mixed with a Henschel mixer to obtain a toner (1).

### Preparation of Resin Particle Dispersion (3)

1,10-Decanedicarboxylic acid (manufactured by FUJIFILM Wako Pure Chemical Corporation): 260 parts
1,6-Hexandiol (manufactured by FUJIFILM Wako Pure Chemical Corporation): 167parts
Dibutyl tin oxide (catalyst): 0.3 parts

The above-described materials are charged into a flask, the air in the flask is replaced with nitrogen gas to be under an inert atmosphere, and the mixture is stirred and refluxed at 180° C. for 5 hours by mechanical stirring. Next, the temperature is slowly raised to 230° C. under reduced pressure, and the components are stirred for 2 hours. At a point in time when the components have turned viscous, the reaction system is air-cooled such that the reaction is stopped. In this way, a crystalline polyester having a weight-average molecular weight of 12,500 and a melting temperature of 73° C. is obtained. 90 parts of the crystalline polyester resin, 1.8 parts of an anionic surfactant (TaycaPower, manufactured by Tayca Corporation, solid content: 12%, sodium dodecylbenzene sulfonate), and 210 parts of deionized water are mixed with each other, heated to 120° C., and dispersed using a homogenizer (ULTRA-TURRAX T50, manufactured by IKA) and then subjected to a dispersion treatment for 1 hour with a pressure jet type homogenizer to obtain a resin particle dispersion liquid (3) having a volume-average particle size of 195 nm and a solid content of 30%.

### Synthesis of Amorphous Polyester Resin (A)

Terephthalic acid: 68 parts
Fumaric acid: 32 parts
Ethylene glycol: 42 parts
1,5-Pentanediol: 47 parts

The above-described materials are charged into a flask equipped with a stirring device, a nitrogen introduction pipe, a temperature sensor, and a rectification column, the temperature of the reaction solution is raised to 220° C. over 1 hour under nitrogen gas stream, and 1 part of titanium tetraethoxide with respect to the total of 100 parts of the above-described materials is added thereto. While the generated water is distilled off, the temperature is raised to 240° C. over 0.5 hours, a dehydration condensation reaction is continued for 1 hour at 240° C., and then the reaction product is cooled. In this manner, an amorphous polyester resin (A) having a weight-average molecular weight of 97,000 and a glass transition temperature of 60° C. is obtained.

### Production of Amorphous Polyester Resin Particle Dispersion (A1)

40 parts of ethyl acetate and 25 parts of 2-butanol are put in a container equipped with a temperature control unit and a nitrogen purge unit, thereby preparing a mixed solvent. Thereafter, 100 parts of the amorphous polyester resin (A) is slowly added to and dissolved in the solvent, a 10% aqueous ammonia solution (in an amount equivalent to 3 times the acid value of the resin in terms of molar ratio) is added thereto, and the mixed solution is stirred for 30 minutes. Next, the inside of the container is replaced with dry nitrogen, the temperature is kept at 40° C., and 400 parts of deionized water is added dropwise thereto while stirring the mixed solution for emulsification. After the dropwise addition is completed, the emulsion is returned to 25° C., thereby obtaining a resin particle dispersion in which resin particles having a volume-average particle size of 195 nm are dispersed. Deionized water is added to the resin particle dispersion to adjust the solid content to 20%, thereby obtaining an amorphous polyester resin particle dispersion (4).

### Production of Styrene Acrylic Resin Particle Dispersion (S1)

Styrene: 375 parts
n-Butyl acrylate: 25 parts
Acrylic acid: 2 parts
Dodecanethiol: 24 parts
Carbon tetrabromide: 4 parts

A mixture obtained by mixing and dissolving the above-described materials is dispersed and emulsified in a surfactant solution obtained by dissolving 6 parts of a nonionic surfactant (manufactured by Sanyo Chemical Industries, Ltd., NONIPOL 400) and 10 parts of an anionic surfactant (Tayca Power, manufactured by Tayca Co., Ltd., solid content: 12% by mass, sodium dodecylbenzenesulfonate) in 550 parts of deionized water in a flask. Next, the mixture in the flask is stirred, and in this state, an aqueous solution obtained by dissolving 4 parts of ammonium persulfate in 50 parts of deionized water is added thereto for 20 minutes. Next, nitrogen purging is performed, and in a state in which the mixture in the flask is stirred, the flask is heated in an oil bath until the temperature of the content reaches 70° C., and the temperature is kept at 70° C. for 5 hours so that emulsion polymerization continues. In this manner, a resin particle dispersion liquid in which resin particles having a volume-average particle size of 150 nm are dispersed is obtained. Deionized water is added to the resin particle dispersion to adjust the solid content to 20%, thereby obtaining a styrene acrylic resin particle dispersion (S1).

### Production of Colored Toner

### Production of Cyan Toner (CT1)

### First Aggregated Particle-Forming Step

Deionized water: 200 parts
Colorant particle dispersion liquid (Cy1): 15 parts
Release agent particle dispersion (W1): 10 parts
Styrene acrylic resin particle dispersion (S1): 60 parts
Crystalline polyester resin particle dispersion (B1): 10 parts
Amorphous polyester resin particle dispersion (A1): 310 parts

The above-described materials are added to a round stainless steel flask, 0.1 N (=0.1 mol/L) of nitric acid is added thereto such that the pH is adjusted to 3.5, and a magnesium chloride aqueous solution obtained by dissolving 6 parts of magnesium chloride in 30 parts of deionized water is added thereto. The obtained solution is dispersed at 30° C. by using a homogenizer (ULTRA-TURRAX T50 manufactured by IKA), heated to 45° C. in an oil bath for heating, and retained until the volume-average particle size reaches 4.5 μm.

### Second Aggregated Particle-Forming Step

Next, 5 parts of the styrene acrylic resin fine particle dispersion liquid (S1) is added dropwise thereto, and the mixture is allowed to stand for 30 minutes. 5 parts of the styrene acrylic resin fine particle dispersion liquid (S1) is added thereto 4 times in total every 30 minutes. Thereafter, while continuing the stirring, the pH is adjusted to 9.0 using a 1 N (=0.1 mol/L) sodium hydroxide aqueous solution.

### Coalescence Step

Next, while continuing the stirring, the temperature is raised to 85° C. at a temperature raising rate of 0.5° C./min, maintained at 85° C. for 3 hours, and then lowered to 30° C. at a cooling rate of 15° C./min (first cooling). Next, the temperature is raised (re-heated) to 85° C. at a temperature raising rate of 0.2° C./min, maintained for 30 minutes, and then lowered to 30° C. at a cooling rate of 0.5° C./min (second cooling). Next, the solid content is filtered, washed with deionized water, and dried to obtain cyan toner particles having a volume-average particle size of 4.7 μm.

100 parts of the above-described toner particles and 3 parts of silica particles (treated with hexamethyldisilazane for surface hydrophobization, average primary particle size: 40 nm) are mixed with a Henschel mixer to obtain a toner (2).

### Production of Magnetic Particles

### Production of Magnetic Particles 1

1,307 parts of Fe₂O₃, 712 parts of Mn(OH)₂, 10.5 parts of Mg(OH)₂, and 20 parts of CaCO₃ are mixed with each other, polycarboxylate as a dispersant, water, and zirconia beads having a diameter of 1 mm are added thereto, and the mixture is crushed and mixed using a sand mill. The zirconia beads are separated by filtration, and the filtrate is dried and then temporarily fired using a rotary kiln under the conditions of rotation speed of 20 rpm/temperature of 900° C./2 hours. Polycarboxylate and water are added to the obtained temporarily fired product as a dispersant, 8 parts of polyvinyl alcohol are further added thereto, and the mixture is pulverized and mixed for 5 hours using a wet-type ball mill. A volume-average particle size of the obtained pulverized product is 1.2 μm. Next, the product is made into granules having a particle size of 34 μm using a spray dryer. The obtained granulated product is permanently baked using an electric furnace in an oxygen/nitrogen mixed atmosphere having an oxygen concentration of 1% by volume under conditions of temperature of 1,420° C./6 hours. Furthermore, the obtained baked product is crushed and classified. After undergoing the crushing and classification of the obtained particles, the particles are heated in a rotary kiln at 15 rpm and 900° C. for 2 hours (post step), and further classified to obtain magnetic particles 1. A volume-average particle size of the magnetic particles 1 is 32 m, and a BET specific surface area thereof is 0.18 m²/g.

### Production of Magnetic Particles 2 to 10

Magnetic particles 2 to 10 are each produced in the same manner as in the production of the magnetic particles 1, except that the raw materials and various conditions are changed as shown in Table 1.

TABLE 1

| | | | | | | Tempo- | | Permanently firing | | | | | |
|---|---|---|---|---|---|---|---|---|---|---|---|---|---|
| | | | | | | rarily | | | Oxygen | | | Volume- | BET |
| | | | | | | firing | Granule | | concen- | | Post step | average | specific |
| | | | | | | Particle | Particle | Temper- | tration | | Temper- | particle | surface |
| | Raw material (part by mass) | | | | | size | size | ature | (% by | | ature | size | area |
| | Fe₂O₃ | Mn(OH)₂ | Mg(OH)₂ | SrCO₃ | CaCO₃ | (μm) | (μm) | (° C.) | volume) | Time | (° C.) | (μm) | (m²/g) |
| Magnetic | 1307 | 712 | 10.5 | — | 20 | 1.2 | 34 | 1420 | 1.0 | 6 | 900 | 32 | 0.18 |
| particles 1 | | | | | | | | | | | | | |
| Magnetic | 1307 | 712 | 10.5 | — | 20 | 1.2 | 30 | 1420 | 1.0 | 6 | 900 | 29 | 0.22 |
| particles 2 | | | | | | | | | | | | | |
| Magnetic | 1307 | 712 | 10.5 | — | 20 | 1.2 | 38 | 1400 | 1.0 | 6 | 900 | 37 | 0.16 |
| particles 3 | | | | | | | | | | | | | |
| Magnetic | 1307 | 712 | 10.5 | 29.5 | — | 2.2 | 35 | 1400 | 0.9 | 7.5 | 900 | 33 | 0.10 |
| particles 4 | | | | | | | | | | | | | |
| Magnetic | 1307 | 712 | 10.5 | — | 20 | 1.0 | 34 | 1390 | 1.1 | 6.5 | 900 | 32 | 0.26 |
| particles 5 | | | | | | | | | | | | | |
| Magnetic | 1307 | 734 | — | 44 | — | 1.4 | 34 | 1420 | 0.9 | 7 | 940 | 33 | 0.14 |
| particles 6 | | | | | | | | | | | | | |
| Magnetic | 1307 | 712 | 10.5 | — | 20 | 1.0 | 33 | 1420 | 1.0 | 6 | 900 | 32 | 0.20 |
| particles 7 | | | | | | | | | | | | | |
| Magnetic | 1307 | 712 | 10.5 | — | 20 | 1.1 | 32 | 1410 | 1.0 | 6 | 900 | 31 | 0.24 |
| particles 8 | | | | | | | | | | | | | |
| Magnetic | 1307 | 712 | 10.5 | — | 20 | 2.2 | 34 | 1400 | 1.0 | 6.5 | 920 | 33 | 0.12 |
| particles 9 | | | | | | | | | | | | | |
| Magnetic | 1307 | 712 | 10.5 | — | 20 | 1.3 | 35 | 1410 | 0.9 | 6 | 910 | 33 | 0.22 |
| particles 10 | | | | | | | | | | | | | |

### Production of Inorganic Particles

### Production of Inorganic Particles 1

Metatitanic acid that is a desulfurized and deflocculated titanium source is collected in an amount of 0.7 mol as TiO₂ and put in a reaction vessel. Next, 0.77 mol of an aqueous strontium chloride solution is added to the reaction vessel such that the molar ratio of SrO/TiO₂ is 1.1. Next, a solution obtained by dissolving silicon dioxide in nitric acid is added to the reaction container in an amount such that the amount of silicon is 2.5 mol with respect to 100 mol of strontium. The initial TiO₂ concentration in the mixed solution of the three materials is adjusted to 0.75 mol/L. Next, the mixed solution is stirred and heated to 90° C., 153 mL of a 10 N(=10 mol/L) sodium hydroxide aqueous solution is added thereto for 4 hours in a state where the mixed solution is stirred at a liquid temperature kept at 90° C., and the obtained reaction solution is continuously stirred for 1 hour at a liquid temperature kept at 90° C. Next, the reaction solution is cooled to 40° C., hydrochloric acid is added thereto until the pH reaches 5.5, and the reaction solution is stirred for 1 hour. Next, decantation and redispersion in water are repeated to wash the precipitate. Hydrochloric acid is added to the slurry containing the washed precipitate such that the pH is adjusted to 6.5, and the solids are separated by filtration and dried. i-Butyltrimethoxysilane (i-BTMS) in an ethanol solution is added to the dried solids, in an amount that makes the amount of the i-BTMS be 20 parts with respect to 100 parts of the solids, followed by stirring for 1 hour. The solid content is filtered, and dried in an atmosphere of 130° C. for 7 hours to obtain inorganic particles 1.

The circularity can be adjusted by the temperature of the mixed solution and the amount of sodium hydroxide to be added. The value of the circularity can be increased by setting the temperature of the mixed solution to be high; and the value of the circularity can be decreased by setting the temperature of the mixed solution to be low. In addition, the circularity can be adjusted by the amount of sodium hydroxide to be added. The value of circularity increases in a case where the amount of sodium hydroxide is small; and the value of circularity decreases in a case where the amount of sodium hydroxide is large. The circularity is adjusted by the temperature of the mixed solution and the amount of sodium hydroxide.

The circularity at which the cumulative percentage reaches 84% can be adjusted by the addition time of sodium hydroxide. In a case where the addition time is long, the value of the circularity at which the cumulative percentage reaches 84% is large; and in a case where the addition time is short, the value of the circularity at which the cumulative percentage reaches 84% is small.

### Production of Inorganic Particles 2 to 17

Inorganic particles 2 to 17 are produced in the same manner as in the production of the inorganic particles 1, except that the type of the dopant, the time taken for the dropwise addition of the 10 N sodium hydroxide aqueous solution, the average primary particle size, the average circularity, and the circularity at which the cumulative percentage reaches 84% are adjusted as shown in Table 2. The inorganic particles 7 are produced in the same manner as in the production of the inorganic particles 1, except that silicon is added in an amount of 12.5 mol with respect to 100 mol of strontium. In the column of the dopant of the inorganic particles 7 in Table 2, “Si-rich” is described.

TABLE 2

| | | | | | Circularity at | |
|---|---|---|---|---|---|---|
| | | | | | which | |
| | | | Average primary | | cumulative | |
| | | | particle size | Average | percentage | |
| | Formulation | Dopant | (nm) | circularity | reaches 84% | Mx/Mt |
| Inorganic particles 1 | SrTiO₃ | Si | 50 | 0.925 | 0.952 | 0.80 |
| Inorganic particles 2 | SrTiO₃ | Si | 80 | 0.824 | 0.922 | 0.80 |
| Inorganic particles 3 | SrTiO₃ | Si | 30 | 0.938 | 0.973 | 0.80 |
| Inorganic particles 4 | SrTiO₃ | Si | 80 | 0.856 | 0.932 | 0.80 |
| Inorganic particles 5 | SrTiO₃ | Si | 60 | 0.903 | 0.924 | 0.80 |
| Inorganic particles 6 | SrTiO₃ | La | 50 | 0.925 | 0.952 | 0.80 |
| Inorganic particles 7 | SrTiO₃ | Si-rich | 80 | 0.814 | 0.922 | 0.80 |
| Inorganic particles 8 | SrTiO₃ | None | 40 | 0.948 | 0.978 | 0.80 |
| Inorganic particles 9 | SrTiO₃ | Si | 40 | 0.900 | 0.916 | 0.80 |
| Inorganic particles 10 | CaTiO₃ | Si | 50 | 0.925 | 0.952 | 0.80 |
| Inorganic particles 11 | BaTiO₃ | Si | 50 | 0.925 | 0.952 | 0.80 |
| Inorganic particles 12 | SrTiO₃ | Si | 50 | 0.925 | 0.952 | 0.60 |
| Inorganic particles 13 | SrTiO₃ | Si | 50 | 0.925 | 0.952 | 0.95 |
| Inorganic particles 14 | SrTiO₃ | None | 50 | 0.900 | 0.920 | 0.80 |
| Inorganic particles 15 | SrTiO₃ | Si | 50 | 0.925 | 0.952 | 0.65 |
| Inorganic particles 16 | SrTiO₃ | Si | 50 | 0.925 | 0.952 | 0.90 |
| Inorganic particles 17 | SrTiO₃ | Si | 50 | 0.920 | 0.920 | 0.80 |

In Table 2 and Table 4 described later, Mx/Mt indicates a ratio of the molar amount Mt of Ti to the total molar amount Mx of Ca, Sr, and Ba in the inorganic particles.

### Preparation of Coating Agent 1

Cyclohexyl methacrylate-dimethylaminoethyl methacrylate copolymer (polymerization mass ratio: 99.5:0.5, weight-average molecular weight: 80,000): 36 parts
Carbon black (VXC72, Cabot Corporation.): 4 parts
Melamine resin particles (EPOSTAR S, manufactured by NIPPON SHOKUBAI CO., LTD.): 3 parts
Toluene: 180 parts
Isopropanol: 30 parts

The above-described materials and glass beads (diameter 1 mm, the same amount as toluene) are put in a sand mill (Kansai Paint Co., Ltd.) and stirred at a rotation speed of 1,200 rpm for 30 minutes, thereby preparing a coating agent 1.

### Preparation of Coating Agent 2

Cyclohexyl methacrylate homopolymer (weight-average molecular weight: 80,000): 36 parts
Carbon black (VXC72, Cabot Corporation.): 4 parts
Melamine resin particles (EPOSTAR S, manufactured by NIPPON SHOKUBAI CO., LTD.): 3 parts
Toluene: 180 parts
Isopropanol: 30 parts

The above-described materials and glass beads (diameter 1 mm, the same amount as toluene) are put in a sand mill (Kansai Paint Co., Ltd.) and stirred at a rotation speed of 1,200 rpm for 30 minutes, thereby preparing a coating agent 2.

### Preparation of Coating Agent 3

Cyclohexyl methacrylate-dimethylaminoethyl methacrylate copolymer (polymerization mass ratio: 99.5:0.5, weight-average molecular weight: 80,000): 36 parts
Carbon black (VXC72, Cabot Corporation.): 4 parts
Melamine resin particles (EPOSTAR S, manufactured by NIPPON SHOKUBAI CO., LTD.): 3 parts
Inorganic particles 1: 15 parts
Toluene: 180 parts
Isopropanol: 30 parts

The above-described materials and glass beads (diameter 1 mm, the same amount as toluene) are put in a sand mill (Kansai Paint Co., Ltd.) and stirred at a rotation speed of 1,200 rpm for 30 minutes, thereby preparing a coating agent 3.

### Preparation of Coating Agent 4

A coating agent 4 is prepared in the same manner as in the preparation of the coating agent 1, except that the cyclohexyl methacrylate-dimethylaminoethyl methacrylate copolymer in the coating agent 1 is changed to a methyl methacrylate polymer (weight-average molecular weight: 50,000).

### Examples 1 to 27 and Comparative Examples 1 to 5

### Production of Electrostatic Charge Image Developing Carrier

The inorganic particles shown in Table 3 are put into a vacuum degassing type kneader in the amounts shown in Table 3, the coating agent shown in Table 3 is further put into the vacuum degassing type kneader in the amounts shown in Table 3, and the mixture is heated and depressurized while being stirred. Thereafter, the mixture is further heated and depressurized to atmospheric pressure−200 mmHg at 60° C., and stirred for 15 minutes, further heated and depressurized to 94° C. and atmospheric pressure−720 mmHg, and stirred for 30 minutes. Thereafter, the pressure is released, and the mixture is dried with stirring for 10 minutes. The obtained particles are sieved through a sieve having an opening of 75 μm to obtain each of carriers 1 to 14.

TABLE 3

| | | | | | | Carrier | | |
|---|---|---|---|---|---|---|---|---|
| | Magnetic particles | | | Coating agent | | Volume- | Coating | |
| | | BET specific | Amount | | Amount | average | amount | |
| | | surface area | (part by | | (part by | particle size | (part by | Fluidity of |
| | Type | (m²/g) | mass) | Type | mass) | (μm) | mass) | carrier |
| Carrier 1 | Magnetic | 0.18 | 2000 | Coating agent 1 | 420 | 33 | 0.030 | 30 |
| | particles 1 | | | | | | | |
| Carrier 2 | Magnetic | 0.22 | 2000 | Coating agent 1 | 420 | 30 | 0.030 | 31 |
| | particles 2 | | | | | | | |
| Carrier 3 | Magnetic | 0.16 | 2000 | Coating agent 1 | 420 | 38 | 0.030 | 29 |
| | particles 3 | | | | | | | |
| Carrier 4 | Magnetic | 0.10 | 2000 | Coating agent 1 | 420 | 34 | 0.030 | 30 |
| | particles 4 | | | | | | | |
| Carrier 5 | Magnetic | 0.26 | 2000 | Coating agent 1 | 420 | 33 | 0.030 | 33 |
| | particles 5 | | | | | | | |
| Carrier 6 | Magnetic | 0.14 | 2000 | Coating agent 1 | 420 | 34 | 0.030 | 26 |
| | particles 6 | | | | | | | |
| Carrier 7 | Magnetic | 0.20 | 2000 | Coating agent 1 | 500 | 32 | 0.035 | 34 |
| | particles 7 | | | | | | | |
| Carrier 8 | Magnetic | 0.24 | 2000 | Coating agent 1 | 430 | 32 | 0.031 | 31 |
| | particles 8 | | | | | | | |
| Carrier 9 | Magnetic | 0.12 | 2000 | Coating agent 1 | 420 | 34 | 0.030 | 29 |
| | particles 9 | | | | | | | |
| Carrier 10 | Magnetic | 0.18 | 2000 | Coating agent 2 | 420 | 33 | 0.030 | 30 |
| | particles 1 | | | | | | | |
| Carrier 11 | Magnetic | 0.18 | 2000 | Coating agent 3 | 420 | 33 | 0.030 | 30 |
| | particles 1 | | | | | | | |
| Carrier 12 | Magnetic | 0.22 | 2000 | Coating agent 1 | 380 | 34 | 0.027 | 25 |
| | particles 10 | | | | | | | |
| Carrier 13 | Magnetic | 0.12 | 2000 | Coating agent 1 | 500 | 33 | 0.035 | 35 |
| | particles 6 | | | | | | | |
| Carrier 14 | Magnetic | 0.18 | 2000 | Coating agent 4 | 420 | 33 | 0.030 | 30 |
| | particles 1 | | | | | | | |

1,500 parts of the carrier described in Table 4 below are put into a V-type mixer, and then 0.75 parts of the inorganic particles described in Table 4 below are put into the V-type mixer; and stirring is carried out for 30 minutes under the condition of 25 revolutions per minute (rpm) to obtain each of the electrostatic charge image developing carriers.

### Production of Electrostatic Charge Image Developer

120 parts of the toner (1) are added to the obtained electrostatic charge image developing carrier in the above-described V-type mixer, and the mixture is stirred under the condition of 25 rpm for 20 minutes. Thereafter, the mixture is sieved through a sieve having an opening of 75 μm to obtain each of developers 1 to 30 (electrostatic charge image developers).

### Evaluation of Line Density and White Spot Suppression Property

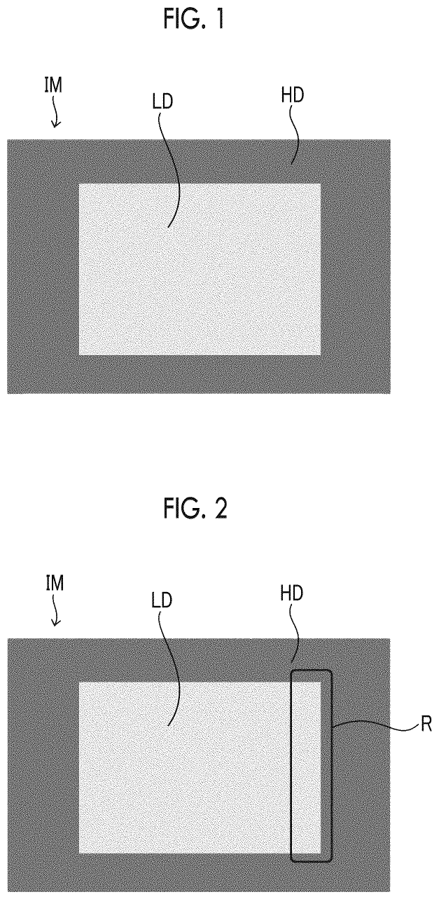

A target electrostatic charge image developer is loaded at a Cyan position of Apeos Print C5570 (manufactured by FUJIFILM Business Innovation Corp.). Five lines having a length of 20 cm and a width of 1.0 pt are printed on A4 paper at an interval of 2 cm. The printing is performed on 3,000 sheets at a printing speed of 55 sheets/min. Line densities of the first sheet and the 3,000 th sheet of the printing are compared. In this case, C5570 adjusted the parameters so that the toner concentration of the electrostatic charge image developer is fixed at 6%, and the printing is performed under the conditions of 12° C. and 10% RH. Next, an image IM shown in FIG. 1 is printed, and a printing density of a portion R shown in FIG. 2 is confirmed in the image IM shown in FIG. 1. An image density of a high-density image HD is set to 1.8 and an image density of a low-density image LD is set to 0.5 (each image density is a cyan density measurement value by X-Rite 404 density measuring instrument manufactured by X-Rite, Inc.).

### Comparison of Line Densities of First Sheet L1 and 3,000 th Sheet L3

G5: there is no difference in image density between L1 and L3 even at 20× magnification.
G4: there is no difference in visual observation, but it is confirmed that the line of L3 is slightly thin at 20× magnification.
G3: there is no difference in visual observation, but L3 is faint at 20× magnification.
G2: it is confirmed that L3 is thin by visual observation.
G1: the line of L3 is thin and fine.

### Evaluation of White Spot Suppression Property (Image Comparison in FIG. 1)

G5: there is no abnormality in the portion shown in FIG. 2.
G4: the portion shown in FIG. 2 is slightly thin.
G3: the portion shown in FIG. 2 is clearly thin.
G2: the portion shown in FIG. 2 is white.
G1: a large portion shown in FIG. 2 is missing.

The evaluation results are collectively shown in Table 4.

TABLE 4

| | | | Electrostatic charge image developing carrier | | | | | | | |
|---|---|---|---|---|---|---|---|---|---|---|
| | | | | V [symbol] | BET specific | | | | | Internally |
| | | | | average | surface area of | | | | | added |
| | Type of | | | particle | magnetic | | | | | Inorganic |
| | developes | Toner | Type | size (μm) | particles (m²/g) | Fluidity | C [symbol] | C [symbol] | C [symbol] | particles |
| Example 1 | Developer 1 | Toner 1 | Carrier 1 | 33 | 0.16 | 30 | CHMA | DMAEMA | — | — |
| Example 2 | Developer 2 | Toner 1 | Carrier 1 | 33 | 0.16 | 30 | CHMA | DMAEMA | — | — |
| Example 3 | Developer 3 | Toner 1 | Carrier 1 | 33 | 0.18 | 30 | CHMA | DMAEMA | — | — |
| Example 4 | Developer 4 | Toner 1 | Carrier 1 | 33 | 0.18 | 30 | CHMA | DMAEMA | — | — |
| Example 5 | Developer 5 | Toner 1 | Carrier 1 | 33 | 0.18 | 30 | CHMA | DMAEMA | — | — |
| Example 6 | Developer 6 | Toner 1 | Carrier 9 | 34 | 0.12 | 29 | CHMA | DMAEMA | — | — |
| Example 7 | Developer 7 | Toner 1 | Carrier 8 | 32 | 0.24 | 31 | CHMA | DMAEMA | — | — |
| Example 8 | Developer 8 | Toner 1 | Carrier 1 | 33 | 0.18 | 30 | CHMA | DMAEMA | — | — |
| Example 9 | Developer 9 | Toner 1 | Carrier 1 | 33 | 0.16 | 30 | CHMA | DMAEMA | — | — |
| Example 10 | Developer 10 | Toner 1 | Carrier 1 | 33 | 0.16 | 30 | CHMA | DMAEMA | — | — |
| Example 11 | Developer 11 | Toner 1 | Carrier 1 | 33 | 0.18 | 30 | CHMA | DMAEMA | — | — |
| Example 12 | Developer 12 | Toner 1 | Carrier 1 | 33 | 0.18 | 30 | CHMA | DMAEMA | — | — |
| Example 13 | Developer 13 | Toner 1 | Carrier 1 | 33 | 0.16 | 30 | CHMA | DMAEMA | — | — |
| Example 14 | Developer 14 | Toner 1 | Carrier 1 | 33 | 0.18 | 30 | CHMA | DMAEMA | — | — |
| Example 15 | Developer 15 | Toner 1 | Carrier 1 | 33 | 0.18 | 30 | CHMA | DMAEMA | — | — |
| Example 16 | Developer 16 | Toner 1 | Carrier 1 | 33 | 0.16 | 30 | CHMA | DMAEMA | — | — |
| Example 17 | Developer 17 | Toner 1 | Carrier 6 | 34 | 0.14 | 26 | CHMA | DMAEMA | — | — |
| Example 18 | Developer 18 | Toner 1 | Carrier 7 | 32 | 0.2 | 34 | CHMA | DMAEMA | — | — |
| Example 19 | Developer 19 | Toner 1 | Carrier 12 | 34 | 0.22 | 25 | CHMA | DMAEMA | — | — |
| Example 20 | Developer 20 | Toner 1 | Carrier 13 | 34 | 0.12 | 35 | CHMA | DMAEMA | — | — |
| Example 21 | Developer 21 | Toner 1 | Carrier 10 | 33 | 0.18 | 30 | CHMA | — | — | — |
| Example 22 | Developer 22 | Toner 1 | Carrier 2 | 3 [symbol] | 0.22 | 31 | CHMA | DMAEMA | — | — |
| Example 23 | Developer 23 | Toner 1 | Carrier 3 | 3 [symbol] | 0.16 | 29 | CHMA | DMAEMA | — | — |
| Example 24 | Developer 24 | Toner 1 | Carrier 11 | 33 | 0.18 | 30 | CHMA | DMAEMA | — | SrTiO₂ |
| Example 25 | Developer 27 | Toner 1 | Carrier 1 | 33 | 0.18 | 30 | CHMA | DMAEMA | — | — |
| Example 26 | Developer 31 | Toner 1 | Carrier 14 | 33 | 0.18 | 30 | — | — | MMA | — |
| Example 27 | Developer 32 | Toner 1 | Carrier 1 | 33 | 0.18 | 30 | CHMA | DMAEMA | — | — |
| Comparative | Developer 25 | Toner 1 | Carrier 1 | 33 | 0.18 | 30 | CHMA | DMAEMA | — | — |
| Example 1 | | | | | | | | | | |
| Comparativo | Developer 26 | Toner 1 | Carrier 1 | 33 | 0.18 | 30 | CHMA | DMAEMA | — | — |
| Exemple 2 | | | | | | | | | | |
| Comparative | Developer 28 | Toner 1 | Carrier 1 | 33 | 0.18 | 30 | CHMA | DMAEMA | — | — |
| Example 3 | | | | | | | | | | |
| Comparative | Developer 29 | Toner 1 | Carrier 4 | 34 | 0.1 | 30 | CHMA | DMAEMA | — | — |
| Example 4 | | | | | | | | | | |
| Comparative | Developer 30 | Toner 1 | Carrier 5 | 33 | 0.26 | 33 | CHMA | DMAEMA | — | — |
| Example 5 | | | | | | | | | | |

| | [symbol] provided on surface | | | | | | | |
|---|---|---|---|---|---|---|---|---|
| | | | | | Circularity at | | | |
| | | | | | which [symbol] | | Evaluation [symbol] | |
| | | | | Average | percentage | | L [symbol] | |
| | Type | Material | Dopant | circularity | reaches 84% | Mx/M [symbol] | density | [symbol] |
| Example 1 | Inorganic | SrTiO₃ | Si | 0.925 | 0.952 | 0.80 | G5 | G5 |
| | particles 1 | | | | | | | |
| Example 2 | Inorganic | SrTiO₃ | Si | 0.824 | 0.922 | 0.80 | G3 | G3 |
| | particles 2 | | | | | | | |
| Example 3 | Inorganic | SrTiO₃ | Si | 0.938 | 0.973 | 0.80 | G3 | G3 |
| | particles 3 | | | | | | | |
| Example 4 | Inorganic | SrTiO₃ | Si | 0. [symbol] | 0.932 | 0.80 | G4 | G4 |
| | particles 4 | | | | | | | |
| Example 5 | Inorganic | SrTiO₃ | Si | 0.9 [symbol] 3 | 0.924 | 0.80 | G4 | G4 |
| | particles 5 | | | | | | | |
| Example 6 | Inorganic | SrTiO₃ | Si | 0.925 | 0.952 | 0.80 | G3 | G4 |
| | particles 1 | | | | | | | |
| Example 7 | Inorganic | SrTiO₃ | Si | 0.925 | 0.952 | 0.80 | G3 | G4 |
| | particles 1 | | | | | | | |
| Example 8 | Inorganic | SrTiO₃ | Si | TBD | 0.920 | 0.80 | G3 | G3 |
| | particles 17 | | | | | | | |
| Example 9 | Inorganic | SrTiO₃ | La | 0.925 | 0.952 | 0.80 | G5 | G5 |
| | particles 8 | | | | | | | |
| Example 10 | Inorganic | SrTiO₃ | None | 0.9 [symbol] 0 | 0.920 | 0.80 | G5 | G5 |
| | particles 14 | | | | | | | |
| Example 11 | Inorganic | CaTiO₃ | Si | 0.925 | 0.952 | 0.80 | G4 | G4 |
| | particles 10 | | | | | | | |
| Example 12 | Inorganic | BaTiO₃ | Si | 0.925 | 0.952 | 0.80 | G4 | G3 |
| | particles 11 | | | | | | | |
| Example 13 | Inorganic | SrTiO₃ | Si | 0.925 | 0.952 | 0.85 | G4 | G5 |
| | particles 15 | | | | | | | |
| Example 14 | Inorganic | SrTiO₃ | Si | 0.925 | 0.952 | 0.90 | G5 | G4 |
| | particles 16 | | | | | | | |
| Example 15 | Inorganic | SrTiO₃ | Si | 0.925 | 0.952 | 0.60 | G3 | G4 |
| | particles 12 | | | | | | | |
| Example 16 | Inorganic | SrTiO₃ | Si | 0.925 | 0.952 | 0.95 | G5 | G3 |
| | particles 13 | | | | | | | |
| Example 17 | Inorganic | SrTiO₃ | Si | 0.925 | 0.952 | 0.80 | G4 | G4 |
| | particles 1 | | | | | | | |
| Example 18 | Inorganic | SrTiO₃ | Si | 0.925 | 0.952 | 0.80 | G4 | G4 |
| | particles 1 | | | | | | | |
| Example 19 | Inorganic | SrTiO₃ | Si | 0.925 | 0.952 | 0.80 | G3 | G4 |
| | particles 1 | | | | | | | |
| Example 20 | Inorganic | SrTiO₃ | Si | 0.925 | 0.952 | 0.80 | G3 | G4 |
| | particles 1 | | | | | | | |
| Example 21 | Inorganic | SrTiO₃ | Si | 0.925 | 0.952 | 0.80 | G4 | G3 |
| | particles 1 | | | | | | | |
| Example 22 | Inorganic | SrTiO₃ | Si | 0.925 | 0.952 | 0.80 | G4 | G3 |
| | particles 1 | | | | | | | |
| Example 23 | Inorganic | SrTiO₃ | Si | 0.925 | 0.952 | 0.80 | G4 | G3 |
| | particles 1 | | | | | | | |
| Example 24 | None | | | | | | G3 | G3 |
| Example 25 | Inorganic | SrTiO₃ | Si | 0.900 | 0.916 | 0.80 | G2 | G2 |
| | particles 9 | | | | | | | |
| Example 26 | Inorganic | SrTiO₃ | Si | 0.925 | 0.952 | 0.80 | G3 | G4 |
| | particles 1 | | | | | | | |
| Example 27 | Inorganic | SrTiO₃ | Si | 0.925 | 0.952 | 0.65 | G5 | G4 |
| | particles 15 | | | | | | | |
| Comparative | Inorganic | SrTiO₃ | Si-rich | 0.814 | 0.952 | 0.80 | G2 | G1 |
| Example 1 | particles 7 | | | | | | | |
| Comparativo | Inorganic | SrTiO₃ | None | 0.948 | 0.922 | 0.80 | G1 | G2 |
| Exemple 2 | particles 8 | | | | | | | |
| Comparative | T [symbol] | TiO₂ | None | 0.850 | 0.930 | 0 | G1 | G1 |
| Example 3 | particles | | | | | | | |
| Comparative | Inorganic | SrTiO₃ | Si | 0.928 | 0.952 | 0.80 | G2 | G1 |
| Example 4 | particles 1 | | | | | | | |
| Comparative | Inorganic | SrTiO₃ | Si | 0.928 | 0.952 | 0.80 | G1 | G2 |
| Example 5 | particles 1 | | | | | | | |

[symbol]

indicates data missing or illegible when filed

As the titania particles shown in Table 4, T805 manufactured by Nippon Aerosil Co., Ltd. is used.

As shown in Table 4, the electrostatic charge image developing carriers of Examples 1 to 27 are excellent in line density and white spot suppression property in the image to be obtained, as compared with the electrostatic charge image developing carriers of Comparative Examples Ito 5.

### Example 28

A toner (2) is produced in the same manner as in the production of the toner (1), except that, in the toner (1), the amount of the silica particles mixed with the Henschel mixer is set to 3.4 parts by mass, 1.5 parts by mass of the inorganic particles 1 is added after the mixing, and the mixture is mixed with the Henschel mixer.

Next, the carrier 1 and the toner 2 are mixed with the V-type mixer under the same conditions as in the production of the developer 1 to obtain a developer 32.

As a result of performing each of the evaluations described above, the evaluation of the linear density of the developer 32 is G4, and the evaluation of the white spot suppression property is G4.

(((1))) An electrostatic charge image developing carrier comprising:
magnetic particles; and
a resin coating layer on a surface of the magnetic particles,
wherein inorganic particles are provided on a surface of the electrostatic charge image developing carrier or contained in the resin coating layer,
the inorganic particles contains Ti and any of Ca, Sr, or Ba,
an average circularity of primary particles of the inorganic particles is 0.82 or more and 0.94 or less, and
a BET specific surface area of the magnetic particles is 0.12 m²/g or more and 0.24 m²/g or less.

(((2))) The electrostatic charge image developing carrier according to (((1))),
wherein a circularity of the inorganic particles at which a cumulative percentage reaches 84% is more than 0.92.

(((3))) The electrostatic charge image developing carrier according to (((1))) or (((2))),
wherein, in the inorganic particles, a value of a ratio Mx/Mt of a total molar amount Mx of Ca, Sr, and Ba to a molar amount Mt of Ti is 0.65 or more and 0.90 or less.

(((4))) The electrostatic charge image developing carrier according to any one of (((1))) to (((3))),
wherein a fluidity is 26 or more and 34 or less.

(((5))) The electrostatic charge image developing carrier according to any one of (((1))) to (((4))),
wherein the resin coating layer contains an acrylic resin that has an aliphatic cyclic structure and an amino group.

(((6))) The electrostatic charge image developing carrier according to (((5))),
wherein the resin coating layer contains an acrylic resin that has a constitutional unit having an aliphatic cyclic structure and a constitutional unit having an amino group.

(((7))) The electrostatic charge image developing carrier according to any one of (((1))) to (((6))),
wherein an average particle size is 30 μm or more and 38 μm or less.

(((8))) An electrostatic charge image developer comprising:
the electrostatic charge image developing carrier according to any one of (((1))) to (((7))); and
a toner.

(((9))) A process cartridge comprising:
a developing unit that contains the electrostatic charge image developer according to (((8))) and develops an electrostatic charge image formed on a surface of an image holder as a toner image using the electrostatic charge image developer,
wherein the process cartridge is detachable from an image forming apparatus.

(((10))) An image forming method comprising:
charging at least an image holder;
exposing the image holder to form an electrostatic latent image on a surface of the image holder;
developing the electrostatic latent image formed on the surface of the image holder using an electrostatic charge image developer to form a toner image;
transferring the toner image formed on the surface of the image holder to a surface of a transfer object; and
fixing the toner image,
wherein the electrostatic charge image developer is the electrostatic charge image developer according to (((8))).

(((11))) An image forming apparatus comprising:
an image holder;
a charging unit that charges the image holder;
an exposure unit that exposes the charged image holder to form an electrostatic latent image on the image holder;
a developing unit that develops the electrostatic latent image using an electrostatic charge image developer to form a toner image;
a transfer unit that transfers the toner image from the image holder to a transfer object; and
a fixing unit that fixes the toner image,
wherein the electrostatic charge image developer is the electrostatic charge image developer according to (((8))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier comprising:
magnetic particles; and
a resin coating layer on a surface of the magnetic particles,
wherein inorganic particles are provided on a surface of the electrostatic charge image developing carrier or contained in the resin coating layer,
the inorganic particles contains Ti and any of Ca, Sr, or Ba,
an average circularity of primary particles of the inorganic particles is 0.82 or more and 0.94 or less, and
a BET specific surface area of the magnetic particles is 0.12 m²/g or more and 0.24 m²/g or less.

2. The electrostatic charge image developing carrier according to claim 1,
wherein a circularity of the inorganic particles at which a cumulative percentage reaches 84% is more than 0.92.

3. The electrostatic charge image developing carrier according to claim 1,
wherein, in the inorganic particles, a value of a ratio Mx/Mt of a total molar amount Mx of Ca, Sr, and Ba to a molar amount Mt of Ti is 0.65 or more and 0.90 or less.

4. The electrostatic charge image developing carrier according to claim 2,
wherein, in the inorganic particles, a value of a ratio Mx/Mt of a total molar amount Mx of Ca, Sr, and Ba to a molar amount Mt of Ti is 0.65 or more and 0.90 or less.

5. The electrostatic charge image developing carrier according to claim 1,
wherein a fluidity is 26 or more and 34 or less.

6. The electrostatic charge image developing carrier according to claim 2,
wherein a fluidity is 26 or more and 34 or less.

7. The electrostatic charge image developing carrier according to claim 1,
wherein the resin coating layer contains an acrylic resin that has an aliphatic cyclic structure and an amino group.

8. The electrostatic charge image developing carrier according to claim 2,
wherein the resin coating layer contains an acrylic resin that has an aliphatic cyclic structure and an amino group.

9. The electrostatic charge image developing carrier according to claim 7,
wherein the resin coating layer contains an acrylic resin that has a constitutional unit having an aliphatic cyclic structure and a constitutional unit having an amino group.

10. The electrostatic charge image developing carrier according to claim 8,
wherein the resin coating layer contains an acrylic resin that has a constitutional unit having an aliphatic cyclic structure and a constitutional unit having an amino group.

11. The electrostatic charge image developing carrier according to claim 1,
wherein an average particle size is 30 μm or more and 38 μm or less.

12. The electrostatic charge image developing carrier according to claim 2,
wherein an average particle size is 30 μm or more and 38 μm or less.

13. An electrostatic charge image developer comprising:
the electrostatic charge image developing carrier according to claim 1; and
a toner.

14. An electrostatic charge image developer comprising:
the electrostatic charge image developing carrier according to claim 2; and
a toner.

15. A process cartridge comprising:
a developing unit that contains the electrostatic charge image developer according to claim 13 and develops an electrostatic charge image formed on a surface of an image holder as a toner image using the electrostatic charge image developer,
wherein the process cartridge is detachable from an image forming apparatus.

16. A process cartridge comprising:
a developing unit that contains the electrostatic charge image developer according to claim 14 and develops an electrostatic charge image formed on a surface of an image holder as a toner image using the electrostatic charge image developer,
wherein the process cartridge is detachable from an image forming apparatus.

17. An image forming method comprising:
charging at least an image holder;
exposing the image holder to form an electrostatic latent image on a surface of the image holder;
developing the electrostatic latent image formed on the surface of the image holder using an electrostatic charge image developer to form a toner image;
transferring the toner image formed on the surface of the image holder to a surface of a transfer object; and
fixing the toner image,
wherein the electrostatic charge image developer is the electrostatic charge image developer according to claim 13.

18. An image forming method comprising:
charging at least an image holder;
exposing the image holder to form an electrostatic latent image on a surface of the image holder;
developing the electrostatic latent image formed on the surface of the image holder using an electrostatic charge image developer to form a toner image;
transferring the toner image formed on the surface of the image holder to a surface of a transfer object; and
fixing the toner image,
wherein the electrostatic charge image developer is the electrostatic charge image developer according to claim 14.

19. An image forming apparatus comprising:
an image holder;
a charging unit that charges the image holder;
an exposure unit that exposes the charged image holder to form an electrostatic latent image on the image holder;
a developing unit that develops the electrostatic latent image using an electrostatic charge image developer to form a toner image;
a transfer unit that transfers the toner image from the image holder to a transfer object; and
a fixing unit that fixes the toner image,
wherein the electrostatic charge image developer is the electrostatic charge image developer according to claim 13.

20. An image forming apparatus comprising:
an image holder;
a charging unit that charges the image holder;
an exposure unit that exposes the charged image holder to form an electrostatic latent image on the image holder;
a developing unit that develops the electrostatic latent image using an electrostatic charge image developer to form a toner image;
a transfer unit that transfers the toner image from the image holder to a transfer object; and
a fixing unit that fixes the toner image,
wherein the electrostatic charge image developer is the electrostatic charge image developer according to claim 14.
